(19) United States
(12) Patent Application Publication
(10) Pub. No.: US 2014/0148609 A1
(43) Pub. Date: May 29, 2014

(54) THERMAL TREATMENT OF CRUDE ALGAE OIL

(71) Applicant: SAPPHIRE ENRGY, INC., SAN DIEGO, CA (US)

(72) Inventors: Stilianos G. Roussis, Vista, CA (US); Richard J. Cranford, San Diego, CA (US); Daniel J. Sajkowski, Kewadin, MI (US)

(21) Appl. No.: 14/129,085

(22) PCT Filed: Jul. 2, 2012
(86) PCT No.: PCT/US2012/045305

§ 371 Date: Jan. 31, 2014

Related U.S. Application Data
(60) Provisional application No. 61/504,134, filed on Jul. 1, 2011.
(60) Provisional application No. 61/552,628, filed on Oct. 28, 2011.

(51) Int. Cl. C11B 3/00

(52) U.S. Cl. CPC C11B 3/00
USPC 554/176; 554/1

(57) ABSTRACT

Crude algae oils are thermally-treated at temperature(s) in the range of 300-600° C., without catalyst and/or the addition of hydrogen, to produce a higher grade, cleaner algae oil with, for example, reduced oxygen, boiling range, viscosity and/or density, and acid number, in addition, because the thermal treatment reduces metals in the oil and produces carbonaceous solids, it is expected that catalyst deactivation by algae oil feedstocks will be greatly reduced if the crude algae oil or fractions thereof are thermally-treated prior to catalytic upgrading. Oxygen, fatty acids, metals, and metalloids are reduced/removed by the thermal treatment, so that RBI) processing of the crude bio-oil may be reduced or eliminated, and requirements for further deoxygenation and hydrotreating of the thermal products are reduced or eliminated.

### CROSS REFERENCE TO RELATED APPLICATION

This application claims the benefit of U.S. Provisional Application No. 61/504,134, filed Jul. 1, 2011, entitled THERMAL TREATMENT OF CRUDE ALGAE OIL AND OTHER RENEWABLE OILS FOR IMPROVED OIL QUALITY, and also claims the benefit of U.S. Provisional Application No. 61/552,628, filed Oct. 28, 2011, entitled THERMAL TREATMENT OF ALGAE OIL, each of which is herein incorporated by reference in its entirety for all purposes.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

Increasing energy demands and decreasing fossil petroleum reserves require that renewable energy sources be developed and improved. Meeting this need with renewable oils from biomass will be more feasible and economical if the renewable oil can be treated efficiently in existing petroleum refineries or at least with conventional petroleum refining processes. This way, decades of research, development, and capital investment may be utilized to process and upgrade refinery-compatible renewable oils or blends of renewable oils and fossil petroleum oils.

There has been growing interest in biomass as an alternative source of hydrocarbons for use as fuels. Biomass comprising photosynthetic microorganisms, such as photosynthetic microalgae and photosynthetic bacteria, such as cyanobacteria, will be especially useful due to the ability of these microorganisms to remove carbon dioxide from the atmosphere and the fact that they do not directly compete with food production for resources such as valuable crop land and water.

Patent literature mentions algae as a possible source of renewable oil, but groups algae oil with vegetable and other plant oils when proposing possible replacements for, or supplements to fossil-petroleum-derived feedstocks. The assumption has been made in the patent literature that algae oil can be upgraded by the same processes and conditions that are proposed for vegetable and plant oils, such as canola, corn, soybean, sunflower, palm and sorghum oils, which are nearly entirely (≈100%) composed of triglycerides. On the contrary, this disclosure explains that the composition of algae oil may be very different from these high triglyceride oils and that the processes and conditions required to upgrade algae oil to fuels and lubricants are expected to be quite different from those appropriate for high-triglyceride vegetable and plant oils.

Certain crude algae oils comprise very few triglyceride compounds. Instead, certain crude algae oils of this disclosure are very complex in that they comprise a wide range of compounds, including fatty acids, Nitrogen (N), Oxygen (O), and Sulfur (S) heteroatom-containing compounds, metals, amides, nitriles, sterols, aromatics (aromatic molecules), unknown compounds that are detected by HT GC-MS but not currently identifiable, compounds with boiling points over 1020 degrees Fahrenheit (° F.), and non-distillables that are not detected by High Temperature Gas Chromatography-Mass Spectrometry (HT-GCMS). Non-limiting examples of heteroatoms are N, O, S, P and C. Other exemplary heteroatoms include metals listed on the Periodic Table of Elements, such as alkali metals, alkaline earth metals, lanthanoids, actinoids, and transition metals.

As a result of this complex composition, certain crude algae oils may not be acceptable feedstocks for the same upgrading-process flowschemes, operating conditions, and/or catalysts as high-triglyceride vegetable and/or plant oils. Further, particular characteristics of these crude algae oils may pose problems or at least concerns for petroleum feedstock refineries. For example, the viscosities of certain crude algae oils pose problems in handling and pipeline transportation, because the crude algae oils are difficult to pour, ship, or otherwise handle. Many of the crude algae oil's heteroatom-containing compounds, high molecular weight compounds, and metals pose catalyst deactivation problems. The high fatty acid content causes concern regarding corrosion, and the possible need for expensive metallurgy in handling and processing equipment.

Therefore, the complex composition of crude algae oils, and particularly the heteroatoms, high molecular weight compounds, metals, and fatty acids of crude algae oils, may dictate unexpected combinations of processes, catalysts, and/or conditions to upgrade the crude algae oil to acceptable product specifications. The thermal treatment embodiments of this disclosure provide solutions for one or more of the above-mentioned problems and/or concerns, and simplify the subsequent upgrading processes required for integrating algae oil into conventional refineries, product pools, and/or specialty product markets.

### SUMMARY OF THE DISCLOSURE

Provided herein is a method of processing a crude algae oil or fraction thereof obtained from a biomass, the method comprising: a) heating the crude algae oil or fraction thereof obtained from the biomass to a maximum temperature in the range of about 300-about 600 degrees Celsius to obtain a thermally-treated algae oil, wherein: i) the thermally-treated algae oil is less dense than the crude algae oil or fraction thereof before heating: ii) the thermally-treated algae oil has a lower heteroatom content than the crude algae oil or fraction thereof before heating; iii) the thermally-treated algae oil has a reduced boiling point distribution as compared to the crude algae oil or fraction thereof before heating; and iv) the thermally-treated algae oil has a reduced metals content as compared to the crude algae oil or fraction thereof before heating; wherein the heating of the crude algae oil or fraction occurs without the addition of hydrogen. In one embodiment, the heating of the crude algae oil also occurs in the absence of a catalyst. In another embodiment, the thermally-treated algae oil has more aromatic molecules as compared to the crude algae oil or fraction thereof before heating. In some embodiments, the heating is coking or visbreaking. In other embodiments, the heating is performed in a petroleum refinery coker, visbreaker or pre-heat train to a processing unit. In another embodiment, the crude algae oil of step a) is obtained by hydrothermal treatment of the biomass. In another embodiment, the crude algae oil of step a) is obtained by a pretreatment step followed by hydrothermal treatment of the biomass. In yet another embodiment, the biomass comprises at least one species of algae. In one embodiment, the algae is a microalgae. In other embodiments, the microalgae is a Chlamydomonas sp., a Dunaliella sp., a Scenedesmus sp., a Desmodesmus sp., a Chlorella sp., a Volvacales sp, a Volvox sp., an Arthrospira sp., a Sprirulina sp., a Botryococcus sp., a Desmid sp., a Hematococcus sp., a Nannochloropsis sp., a Synechococcus sp., a Spirulina sp., a Synechocystis sp., an Athrospira sp., a Prochlorococcus sp., a Chroococcus sp., a Gleoecapsa sp., an Aphanocapsa sp., an Aphanothece sp., a Merismopedia sp., a Microcystis sp., a Coelosphaerium sp., a Prochlorothrix sp., an Oscillatoria sp., a Trichodesmium sp., a Microcoleus sp., a Chroococcidiopisis sp., an Anabaena sp., an Aphanizomenon sp., a Cylindrospermopsis sp., a Cylindrospermum sp., a Tolypothrix sp., a Leptolyngbya sp., a Lyngbya sp., or a Scytonema sp., or any combination thereof. In other embodiments, the microalgae is a Chlamydomonas reinhardtii, Dunaliella salina, Haematococcus pluvialis, Nannochloropsis oceania, Nannochloropsis salina, Scenedesmus dimorphus, Spirulina maximus, Arthrospira fusiformis, Dunaliella viridis, Nannochloropsis oculata, or Dunaliella tertiolecta, or any combination thereof. In one embodiment, the thermally-treated algae oil also has an increased saturated hydrocarbon content as compared to the crude algae oil or fraction thereof before heating. In other embodiments, the saturated hydrocarbon content is a factor of at least 5, a factor of at least 10, or a factor of at least 10 to about 30 greater than the crude algae oil or fraction thereof before heating. In yet another embodiment, the thermally-treated algae oil also has a decreased fatty acid content as compared to the crude algae oil or fraction thereof before heating. In another embodiment, the thermally-treated algae oil also has a reduced total acid number (TAN) as compared to the crude algae oil or fraction thereof before heating. In one embodiment, the thermally-treated algae oil also has reduced viscosity as compared to the crude algae oil or fraction thereof before heating. In another embodiment, the thermally-treated algae oil also has an increased nitrile content as compared to the crude algae oil or fraction thereof before heating. In one embodiment, the thermally-treated algae oil also has a decreased sterol content as compared to the crude algae oil or fraction thereof before heating. In yet another embodiment, the crude algae oil or fraction thereof has been upgraded by one or more processes before being heated. In another embodiment, the crude algae oil or fraction thereof is upgraded by one or more processes after being heated. In some embodiments, the upgrading process is catalytic hydrotreating, fluidized catalytic cracking, mild hydrocracking, hydrocracking, reforming, isomerization, dewaxing, filtration, centrifugation, distillation, fractionation, decarboxylation, hydrogenation, hydrotreating, or any combination of one or more of these processes. In another embodiment, the heating of the crude algae oil is performed before any upgrading process, and the thermally-treated algae oil is not fractionated before being fed to a subsequent upgrading process. In one embodiment, the thermally-treated algae oil deactivates a subsequent unit process catalyst less quickly than does the crude algae oil or fraction thereof undergoing the same subsequent unit process conditions. In another embodiment, the reduced boiling point distribution of the thermally treated algae oil has a decreased 1020 degrees F+ fraction mass percent as compared to the crude algae oil or fraction thereof before heating. In yet another embodiment, the reduced boiling point distribution of the thermally treated algae oil has less than or equal to about 22.7 weight % of its material boiling above 1020 degrees F. In one embodiment, the reduced boiling point distribution of the thermally-treated algae oil has a 1020 degrees F+ fraction mass percent of less than or equal to 22.7. In other embodiments, the density of the thermally-treated algae oil is from about 0.8780 (g/ml) at 22.8 degrees Celsius to about 0.9567 (g/ml) at 22.8 degrees Celsius. In other embodiments, the thermally-treated algae oil is 5 to 20 percent less dense than the crude algae oil. In some embodiments, the thermally-treated algae oil is 2 to 5 percent less dense. 5-8 percent less dense, 8-11 percent less dense, 9-12 percent less dense, 12-30 percent less dense, 30-50 percent less dense, 50-80 percent less dense, 80-100 percent less dense, at least 100 percent less dense, at least 150 percent less dense, or at least 200 percent less dense than the crude algae oil. In another embodiment, the heteroatom is sulfur or oxygen. In some embodiments, the percent oxygen content of the thermally-treated algae oil is from about 0.2 to about 2.9. In other embodiments, the oxygen content of the thermally-treated algae oil is less than 6%, less than 5%, less than 4%, less than 3%, less than 2%, or less than 1%. In yet another embodiment, the crude algae oil has an oxygen content of greater than or equal to 5.0 wt-% and the thermally-treated algae oil has an oxygen content of less than 5.0 wt-%. In some embodiments, the sulfur content of the thermally-treated algae oil is from about 0.1 percent to about 0.4 percent. In other embodiments, the reduced metals content of the thermally-treated algae oil has a reduction in ppms of P, Fe, Cu-63. Zn-66, or Zn-68 as compared to the crude algae oil or fraction thereof before heating. In one embodiment, the heating is done in one or more vessels, the vessel can be an open or a closed vessel. In other embodiments, the heating is either done prior to a continuos flow of the crude algae oil through the one or more vessels or during a continuous flow of the crude algae oil through the one or more vessels. In other embodiments, the vessel is a reactor, a furnace, a tank, a drum, a coil, a conduit, or a pipe. In yet other embodiments, the heating is done in a batch process, a semi-batch process, or a continuos process. In other embodiments, the method further comprises b) holding the crude algae oil at the maximum temperature for a holding period in the range of from about 0.05 hour to about 8 hours, from about 0.01 hour to about 24 hours, from about 0.05 hour to about 24 hours, or from about 0.1 hour to about 1 hour. In some embodiments, the method further comprises b) holding the crude algae oil at the maximum temperature for a holding period in the range of 0 to 24 hours, 0 to 10 hours, 0.5 hour to 2 hours, or 0.5 hour to 1 hour. In other embodiments, the temperature during holding is in the range of plus or minus 5 degrees C., in the range of plus or minus 10 degrees C., or in the range of plus or minus 20 degrees C. from the maximum temperature. In other embodiments, the heating and holding are performed in one or more vessels, and the heating releases and/or forms gas and/or light hydrocarbons that increase pressure in the one or more vessels to a range of 0 psig-1000 psig, 300 psig to 3,000 psig, 0 psig to 100 psig, or 0 psig-300 psig. In some embodiments, the method further comprises b) holding the crude algae oil at the maximum temperature for a holding period in the range of 0.05 hours to 8 hours, wherein the heating and holding are performed in one or more vessels and the heating releases and/or forms gas and/or light hydrocarbons that increase pressure in the one or more vessels to a range of 0 psig-1000 psig, 300 psig to 3,000 psig, 0 psig to 100 psig, or 0 psig-300 psig. In other embodiments, the method further comprises b) holding the crude algae oil at the maximum temperature for a holding period in the range of 0.05 hours to 8 hours, wherein the holding is performed during continuous flow through one or more vessels, and the heating releases and/or forms gas and/or light hydrocarbons that increase pressure in the one or more vessels and that are separated after the thermally-treated algae oil exits the one or more vessels. In yet other embodiments, the pressure in the one or more vessels is in the range of 0 psig-1000 psig, 300 psig to 3,000 psig, 0 psig to 100 psig, or 0 psig-300 psig. In other embodiments, the pressure in the one or more vessels is 0 psig-20 psig, 20 psig-40 psig, 40 psig-60 psig, 60 psig-80 psig, 80 psig-100 psig, 100 psig-120 psig, 120 psig-140 psig, 140 psig-160 psig, 160 psig-180 psig, 180 psig-200 psig, 200 psig-220 psig, 220 psig-240 psig, 240 psig-260 psig, 260 psig-280 psig, 280 psig-300 psig, 300 psig-500 psig, 500 psig-700 psig, 700 psig-900 psig, 900 psig-1000 psig, 1000 psig-1100 psig, 1100 psig-1300 psig, 1300 psig-1500 psig, 1500 psig-1700 psig, 1700 psig-1900 psig, 1900 psig-2100 psig, 2100 psig-2300 psig, 2300 psig-2500 psig, 2500 psig-2700 psig, and/or 2700 psig-3000 psig. In some embodiments, the maximum temperature is from about 350 degrees Celsius to about 450 degrees Celsius, or the maximum temperature is 300-310, 310-320, 320-330, 330-340, 340-350, 350-360, 360-370, 370-380, 380-390, 390-400, 400-410, 410-420, 420-430, 430-440, 440-450, 450-460, 460-470, 470-480, 480-490, 490-500, 500-510, 510-520, 520-530, 530-540, 540-550, 550-560, 560-570, 570-580, 580-590, or 590-600° C. In other embodiments, the maximum temperature is about 350 degrees Celsius, about 400 degrees Celsius, or about 450 degrees Celsius. In some embodiments, the method yields: greater than or equal to 40 wt-% thermally-treated algae oil, and less than or equal to 20 wt % solids, the remainder of the yield being gasses; greater than or equal to 75 wt-% thermally-treated algae oil, and less than or equal to 10 wt % solids, the remainder of the yield being gasses; or greater than or equal to 80 wt-% thermally-treated algae oil, and less than or equal to 5 wt % solids, the remainder of the yield being gasses. In some embodiments, the thermally-treated algae oil has an oxygen content equal to 50% or less of the oxygen content of the crude algae oil; the thermally-treated algae oil has an oxygen content equal to 67% or less of the oxygen content of the crude algae oil; or the thermally-treated algae oil has an oxygen content equal to 10% or less of the oxygen content of the crude algae oil. In other embodiments, the crude algae oil contains 10-20 mass percent material boiling below 630 degrees F, and the thermally-treated algae oil contains greater than 20 mass percent material boiling below 630 degrees F.; the crude algae oil contains 10-20 mass percent material boiling below 630 degrees F, and the thermally-treated algae oil contains greater than 50 mass percent material boiling below 630 degrees F.; the crude algae oil contains 10-20 mass percent material boiling below 630 degrees F, and the thermally-treated algae oil contains greater than 80 mass percent material boiling below 630 degrees F.; the crude algae oil contains less than or equal to 5 mass percent material boiling below 400 degrees F, and the thermally-treated algae oil contains greater than or equal to 15 mass percent material boiling below 400 degrees F.; or the crude algae oil contains less than or equal to 5 mass percent material boiling below 400 degrees F, and the thermally-treated algae oil contains greater than or equal to 50 mass percent material boiling below 400 degrees F. In yet other embodiments, the thermally-treated algae oil contains greater than or equal to 20 mass percent material boiling below 630 degrees F.; the thermally-treated algae oil contains greater than or equal to 50 mass percent material boiling below 630 degrees F.; the thermally-treated algae oil contains greater than or equal to 80 mass percent material boiling below 630 degrees F.; the thermally-treated algae oil contains greater than or equal to 15 mass percent material boiling below 400 degrees F.; the thermally-treated algae oil contains greater than or equal to 50 mass percent material boiling below 400 degrees F.; the thermally-treated algae oil contains less than or equal to 10 mass percent fatty acid moieties; or the thermally-treated algae oil contains less than or equal to 10 mass percent amides plus fatty acids plus sterols.

Also provided herein are thermally-treated algae oils made by any one or more of the above-disclosed methods. In some embodiments, the heating of the crude algae oil is at about 350 degrees Celsius; the heating of the crude algae oil is at about 400 degrees Celsius; or the heating of the crude algae oil is at about 450 degrees Celsius. In other embodiments, the heating of the crude algae oil is at about 350 degrees Celsius, and for the thermally-treated algae oil, the percent oil is about 86.6 percent or greater; the heating of the crude algae oil is at about 400 degrees Celsius, and for the thermally-treated algae oil, the percent oil is about 81.9 percent or greater; or the heating of the crude algae oil is at about 450 degrees Celsius, and for the thermally-treated algae oil, the percent oil is about 40.9 percent or greater. In other embodiments, the heating of the crude algae oil is at about 350 degrees Celsius, and for the thermally-treated algae oil, the percent oil is about 86.6 percent and the percent solids is about 0.4; the heating of the crude algae oil is at about 400 degrees Celsius, and for the thermally-treated algae oil, the percent oil is about 81.9 percent and the percent solids is about 8.1; or the heating of the crude algae oil is at about 450 degrees Celsius, and for the thermally-treated algae oil, the percent oil is about 40.9 percent and the percent solids is about 19.3. In yet other embodiments, the heating of the crude algae oil is at about 350 degrees Celsius, and for the thermally-treated algae oil, the percent oil is about 86.6 percent, the percent solids is about 0.4, the percent gas is about 2.6; the percent losses is about 10.4, and the Pmax (psi) is about 460; the heating of the crude algae oil is at about 400 degrees Celsius, and for the thermally-treated algae oil, the percent oil is about 81.9 percent, the percent solids is about 8.1, the percent gas is about 6.3; the percent losses is about 3.7, and the Pmax (psi) is about 610; or the heating of the crude algae oil is at about 450 degrees Celsius, and for the thermally-treated algae oil, the percent oil is about 40.9 percent, the percent solids is about 19.3, the percent gas is about 18.3; the percent losses is about 21.4, and the Pmax (psi) is about 2910. In some embodiments, the heating of the crude algae oil is at about 350 degrees Celsius, and the thermally-treated algae oil has about 80.8% C, about 11.6% H, about 4.3% N, about 0.4% S, about 2.9% O, a heating value (MJ/kg) of about 44, and a density (g/ml) at 22.8 degrees Celsius of about 0.9567; the heating of the crude algae oil is at about 400 degrees Celsius, and the thermally-treated algae oil has about 83.6% C, about 11.7% H, about 4.2% N, about 0.4% S, about 0.2% O, a heating value (MJ/kg) of about 45, and a density (g/ml) at 22.8 degrees Celsius of about 0.9164; the heating of the crude algae oil is at about 450 degrees Celsius, and the thermally-treated algae oil has about 84.0% C, about 10.1% H, about 4.2% N, about 0.1% S, about 1.6% O, a heating value (MJ/kg) of about 43, and a density (g/ml) at 22.8 degrees Celsius of about 0.8780; or the heating of the crude algae oil is between about 350 and about 450 degrees Celsius, and the thermally-treated algae oil has a % C and a heating value (MJ/kg) that is greater than the crude algae oil before heating, and a % H, a % S, a % 0, and a density (g/ml) at 22.8 degrees Celsius that are each individually less than for the crude algae oil before heating. In other embodiments, the heating of the crude algae oil is at about 350 degrees Celsius; and for the thermally-treated algae oil, the initial—260 degrees F. fraction mass % is 0.0, the 260-400 degrees F. fraction mass % is about 2.1; the 400 to 490 degrees F. fraction mass % is about 5.2; the 490 to 630 degrees F. fraction mass % is about 17.8; the 630-1020 degrees F. fraction mass % is about 52.3; and the 1020 degrees F.—FBP is about 22.5; the heating of the crude algae oil is at about 400 degrees Celsius; and for the thermally-treated algae oil, the initial—260 degrees F. fraction mass % is about 6.5, the 260-400 degrees F. fraction mass % is about 11.4; the 400 to 490 degrees F. fraction mass % is about 12.0; the 490 to 630 degrees F. fraction mass % is about 27.2; the 630-1020 degrees F. fraction mass % is about 36.0; and the 1020 degrees F.—FBP is about 7.0; the heating of the crude algae oil is at 450 degrees Celsius; and for the thermally-treated algae oil, the initial—260 degrees F. fraction mass % is about 23.3, the 260-400 degrees F. fraction mass % is about 28.0; the 400 to 490 degrees F. fraction mass % is about 14.5; the 490 to 630 degrees F. fraction mass % is about 16.1; the 630-1020 degrees F. fraction mass % is about 16.5; and the 1020 degrees F.—FBP is about 1.7; or the heating of the crude algae oil is between 350 and 450 degrees Celsius; and for the thermally-treated algae oil, the initial—260 degrees F. fraction mass % is 0.0 to about 23.3 percent, the 260-400 degrees F. fraction mass % is greater than that of the crude algae oil; the 400 to 490 degrees F. fraction mass % is greater than that of the crude algae oil; the 490 to 630 degrees F. fraction mass % is greater than that of the crude algae oil; the 630-1020 degrees F. fraction mass % is less than that of the crude algae oil; and the 1020 degrees F.—FBP is less than that of the crude algae oil. In yet other embodiments, the heating of the crude algae oil is between about 350 and about 450 degrees Celsius, and for the thermally-treated algae oil, the area % of saturated hydrocarbons is about 23.2 to about 36.6, the area % of unsaturated hydrocarbons is about 1.5 to about 5.4, the area % of aromatic molecules is about 0.3 to about 30.3, the area % of amides is about 0.0 to about 8.5, the area % of nitriles is about 0.5 to about 12.3, the area % of nitrogen aromatics is 0.0 to about 3.5, the area % of fatty acids is 0.0 to about 5.2, the area % of sterols is 0.0, the area % of oxygen containing compounds is about 0.7 to about 1.0, and the area % of sulfur containing compounds is 0.0 to about 1.4.

Also provided herein is a method of processing a crude algae oil or fraction thereof obtained from a biomass, the method comprising: a) heating the crude algae oil or fraction thereof obtained from the biomass in a closed reactor to a maximum temperature in the range of about 300 to about 600 degrees Celsius to obtain a thermally-treated algae oil; and b) holding the maximum temperature or a temperature that is within 5 to 10 degrees Celsius of the maximum temperature for about an hour; wherein the heating and holding of the crude algae oil or fraction occurs without the addition of hydrogen. In one embodiment, the heating of the crude algae oil or fraction also occurs in the absence of a catalyst. In other embodiments, the maximum temperature is about 350 to about 450 degrees Celsius. In some embodiments, the thermally-treated algae oil is less dense than the crude algae oil or fraction thereof before heating; the thermally-treated algae oil has a lower heteroatom content than the crude algae oil or fraction thereof before heating; the thermally-treated algae oil has a reduced boiling point distribution as compared to the crude algae oil or fraction thereof before heating; and the thermally-treated algae oil has a reduced metals content as compared to the crude algae oil or fraction thereof before heating. In one embodiment, the thermally-treated algae oil has more aromatic molecules as compared to the crude algae oil or fraction thereof before heating.

Also provided herein is a thermally-treated algae oil made by the process of: a) heating a crude algae oil or fraction thereof obtained from a biomass to a maximum temperature in the range of about 300-about 600 degrees Celsius to obtain a thermally-treated algae oil, wherein: i) the thermally-treated algae oil is less dense than the crude algae oil or fraction thereof before heating; ii) the thermally-treated algae oil has a lower heteroatom content than the crude algae oil or fraction thereof before heating; iii) the thermally-treated algae oil has a reduced boiling point distribution as compared to the crude algae oil or fraction thereof before heating; and iv) the thermally-treated algae oil has a reduced metals content as compared to the crude algae oil or fraction thereof before heating; wherein the heating of the crude algae oil or fraction occurs without the addition of hydrogen. In one embodiment, the thermally-treated algae oil has more aromatic molecules as compared to the crude algae oil or fraction thereof before heating. In another embodiment, the heating of the crude algae oil or fraction also occurs in the absence of a catalyst. Also provided herein is a thermally-treated algae oil made by the process of: a) heating a crude algae oil or fraction thereof obtained from a biomass to a maximum temperature in the range of about 300-about 600 degrees Celsius to obtain a thermally-treated algae oil; and b) holding the maximum temperature or a temperature that is within 5 to 10 degrees Celsius of the maximum temperature for about an hour; wherein: i) the thermally-treated algae oil is less dense than the crude algae oil or fraction thereof before heating; ii) the thermally-treated algae oil has a lower heteroatom content than the crude algae oil or fraction thereof before heating; iii) the thermally-treated algae oil has a reduced boiling point distribution as compared to the crude algae oil or fraction thereof before heating; and iv) the thermally-treated algae oil has a reduced metals content as compared to the crude algae oil or fraction thereof before heating; wherein the heating and holding of the crude algae oil or fraction occurs without the addition of hydrogen. In one embodiment, wherein the thermally-treated algae oil has more aromatic molecules as compared to the crude algae oil or fraction thereof before heating. In another embodiment, the heating of the crude algae oil or fraction also occurs in the absence of a catalyst.

In addition, provided herein is a thermally-treated algae oil, wherein: a) the thermally-treated algae oil is less dense than a non-thermally treated crude algae oil or fraction thereof obtained from the same species: b) the thermally-treated algae oil has a lower heteroatom content than a non-thermally treated crude algae oil or fraction thereof obtained from the same species; c) the thermally-treated algae oil has a reduced boiling point distribution as compared to a non-thermally treated crude algae oil or fraction thereof obtained from the same species; and d) the thermally-treated algae oil has a reduced metals content as compared to a non-thermally treated crude algae oil or fraction thereof obtained from the same species: wherein the thermal treatment of the crude algae oil or fraction thereof is between about 300 to about 600 degrees Celsius. In one embodiment, the thermally-treated algae oil has more aromatic molecules as compared to the crude algae oil or fraction thereof before heating.

Also provided herein is a thermally-treated algae oil, wherein: a) the thermal treatment is heating a crude algae oil to a temperature of about 350 degrees Celsius, and oil yield after thermal treatment is about 86.6 percent or greater: b) the thermal treatment is heating a crude algae oil to a temperature of about 400 degrees Celsius, and oil yield after thermal treatment is about 81.9 percent or greater: or c) the thermal treatment is heating a crude algae oil to a temperature of about 450 degrees Celsius, and oil yield after thermal treatment is about 40.9 percent or greater.

In addition, provided herein is a thermally-treated algae oil, wherein: a) the thermal treatment is heating a crude algae oil to a temperature of about 350 degrees Celsius, and oil yield after thermal treatment is about 86.6 percent and solid yield after thermal treatment is about 0.4 percent; b) the thermal treatment is heating a crude algae oil to a temperature of about 400 degrees Celsius, and oil yield after thermal treatment is about 81.9 percent and solid yield after thermal treatment is about 8.1 percent; or c) the thermal treatment is heating a crude algae oil to a temperature of about 450 degrees Celsius, and oil yield after thermal treatment is about 40.9 percent and solid yield after thermal treatment is about 19.3 percent.

Also provided herein is a thermally-treated algae oil, wherein: a) the thermal treatment is heating a crude algae oil to a temperature of about 350 degrees Celsius, and oil yield after thermal treatment is about 86.6 percent, solid yield is about 0.4 percent, gas yield is about 2.6 percent, losses is about 10.4 percent, and Pmax (psi) is about 460; b) the thermal treatment is heating a crude algae oil to a temperature of about 400 degrees Celsius, and oil yield after thermal treatment is about 81.9 percent, solid yield is about 8.1 percent, gas yield is about 6.3 percent, losses is about 3.7 percent, and Pmax (psi) is about 610; c) the thermal treatment is heating a crude algae oil to a temperature of about 450 degrees Celsius, and oil yield after thermal treatment is about 40.9 percent, solid yield is about 19.3 percent, gas yield is about 18.3 percent, losses is about 21.4 percent, and Pmax (psi) is about 2910.

In addition, provided herein is a thermally-treated algae oil, wherein: a) the thermal treatment is heating a crude algae oil to a temperature of about 350 degrees Celsius; and the thermally-treated algae oil has about 80.8% C, about 11.6% H, about 4.3% N, about 0.4% S, about 2.9% O, a heating value (MJ/kg) of about 44, and a density (g/ml) at 22.8 degrees Celsius of about 0.9567; b) the thermal treatment is heating a crude algae oil to a temperature of about 400 degrees Celsius; and the thermally-treated algae oil has about 83.6% C, about 11.7% H, about 4.2% N, about 0.4% S, about 0.2% O, a heating value (MJ/kg) of about 45, and a density (g/ml) at 22.8 degrees Celsius of about 0.9164: c) the thermal treatment is heating a crude algae oil to a temperature of about 450 degrees Celsius; and the thermally-treated algae oil has about 84.0% C, about 10.1% H, about 4.2% N, about 0.1% S, about 1.6% O, a heating value (MJ/kg) of about 43, and a density (g/ml) at 22.8 degrees Celsius of about 0.8780: or d) the thermal treatment is heating a crude algae oil to a temperature of about 350 to about 450 degrees Celsius; and the thermally-treated algae oil has a % C and a heating value (MJ/kg) that is greater than the crude algae oil before heating, and a % H, a % S, a % O, and a density (g/ml) at 22.8 degrees Celsius that are each individually less than for the crude algae oil before heating.

Provided herein is a thermally-treated algae oil, wherein: a) the thermal treatment is heating a crude algae oil to a temperature of about 350 degrees Celsius; and for the thermally-treated algae oil, initial—260 degrees F. fraction mass % is 0.0, 260-400 degrees F. fraction mass % is about 2.1; 400 to 490 degrees F. fraction mass % is about 5.2; 490 to 630 degrees F. fraction mass % is about 17.8; 630-1020 degrees F. fraction mass % is about 52.3; and 1020 degrees F.—FBP is about 22.5; b) the thermal treatment is heating a crude algae oil to a temperature of about 400 degrees Celsius; and for the thermally-treated algae oil, initial—260 degrees F. fraction mass % is about 6.5, 260-400 degrees F. fraction mass % is about 11.4; 400 to 490 degrees F. fraction mass % is about 12.0; 490 to 630 degrees F. fraction mass % is about 27.2; 630-1020 degrees F. fraction mass % is about 36.0; and 1020 degrees F.—FBP is about 7.0; c) the thermal treatment is heating a crude algae oil to a temperature of about 450 degrees Celsius; and for the thermally-treated algae oil, initial—260 degrees F. fraction mass % is about 23.3, 260-400 degrees F. fraction mass % is about 28.0; 400 to 490 degrees F. fraction mass % is about 14.5; 490 to 630 degrees F. fraction mass % is about 16.1; 630-1020 degrees F. fraction mass % is about 16.5; and 1020 degrees F.—FBP is about 1.7; or d) the thermal treatment is heating a crude algae oil to a temperature of about 350 to about 450 degrees Celsius; and for the thermally-treated algae oil, initial—260 degrees F. fraction mass % is 0.0 to about 23.3 percent, 260-400 degrees F. fraction mass % is greater than that of the crude algae oil; 400 to 490 degrees F. fraction mass % is greater than that of the crude algae oil; 490 to 630 degrees F. fraction mass % is greater than that of the crude algae oil; 630-1020 degrees F. fraction mass % is less than that of the crude algae oil; and 1020 degrees F.—FBP is less than that of the crude algae oil.

Also provided herein is a thermally-treated algae oil, wherein: a) the thermal treatment is heating a crude algae oil to a temperature of about 350 to about 450 degrees Celsius; and for the thermally-treated algae oil, area % of saturated hydrocarbons is about 23.2 to about 36.6, area % of unsaturated hydrocarbons is about 1.5 to about 5.4, area % of aromatic compounds is about 0.3 to about 30.3, area % of amides is about 0.0 to about 8.5, area % of nitriles is about 0.5 to about 12.3, area % of nitrogen aromatics is 0.0 to about 3.5, area % of fatty acids is 0.0 to about 5.2, area % of sterols is 0.0, area % of oxygen containing compounds is about 0.7 to about 1.0, and area % of sulfur containing compounds is 0.0 to about 1.4.

### BRIEF DESCRIPTION OF THE DRAWINGS

These and other features, aspects, and advantages of the present disclosure will become better understood with regard to the following description, appended claims and accompanying figures where:

FIG. 1 shows HT-GCMS chromatograms of crude algae oil, a 350 degrees Celsius (° C.) thermal product, a 400° C. thermal product, and a 450° C. thermal product.

FIG. 2 shows compound types in a crude algae oil, a 350° C. thermal product, a 400° C. thermal product, and a 450° C. thermal product. The crude algae oil and the 350° C. 400° C., and 450° C. thermal products are shown left to right as the black, dark grey, light gray, and white bars, respectively, except where no bar is shown due to the value being very small or zero. There are no bars for aromatics (aromatic molecules), nitriles, or sulfur compounds in crude algae oil, no bars for sterols in the 350° C. thermal product, no bars for nitrogen-aromatics, sterols, or sulfur compounds in the 400° C. thermal product, and no bars for amides, fatty acids, or sterols for the 450° C. thermal product.

FIG. 3 shows simulated distillation fractions in mass-% of a crude algae oil, a 350° C. thermal product, a 400° C. thermal product, and a 450° C. thermal product. The crude algae oil (“control oil” in this figure) and the 350° C., 400° C., and 450° C. thermal products are shown left to right as the black, dark grey, light gray, and white bars, respectively, and wherein the initial-260° F. bar for the 350° C. thermal product is very small.

FIG. 4 is a proposed reaction scheme that may be useful to explain and understand the products and results from thermal processing of a crude algae oil.

### DETAILED DESCRIPTION

The following detailed description is provided to aid those skilled in the art in practicing the present disclosure. Even so, this detailed description should not be construed to unduly limit the present disclosure as modifications and variations in the embodiments discussed herein can be made by those of ordinary skill in the art without departing from the spirit or scope of the present disclosure.

As used in this specification and the appended claims, the singular forms “a”, “an” and “the” include plural reference unless the context clearly dictates otherwise.

The disclosure relates to methods for thermal treatment of algae oils such as crude algae oils or other algae-derived oils, including those for which the thermal treatment is the first upgrading process after extraction from biomass and those which have been upgraded to some extent before the thermal treatment. More specifically, the disclosure relates to thermal treatment methods that produce renewable feedstocks that are compatible with conventional petroleum refinery units, and that may be upgraded to commercial-grade fuels, lubricants, or petrochemical plant feedstocks with economical operating conditions and catalyst lives. This disclosure also relates to thermal treatment methods and/or apparatus for reducing viscosity and/or density and/or boiling point range of renewable oils (for example, algae oil), to make handling and transport of the oils easier and more economical. The disclosure also related to compositions made by the methods described herein.

A thermal treatment can include, but is not limited to, conventional refining processes such as coking, visbreaking, or a pre-heat train to a processing unit (for example, as described in Leffler, William L., Petroleum Refining for the Non-Technical Person, PennWell Publishing Company, Tulsa, Okla., USA, 1985). Thermal treatment is heating the crude algae oil or fraction thereof to a maximum temperature in the range of 300-600° C. to obtain a thermally-treated algae oil, wherein the heating step is done in the absence of hydrogen, or in the absence of hydrogen and a catalyst, or in the absence of an incondensable gas and a catalyst.

Many embodiments of the thermal treatment of this disclosure reduce oxygen, reduce metals and high molecular weight compounds that deactivate catalysts, reduce boiling point and/or viscosity (including a shift to distillate- and/or naphtha-boiling range fractions), and/or produce other upgraded characteristics in the liquid oil product that are beneficial for downstream (subsequent) processing and/or a refinery product slate or slates. Therefore, embodiments of the present disclosure are expected to increase the compatibility of algae oil with conventional refinery equipment and flow schemes, prevent premature catalyst deactivation, and/or otherwise reduce the cost of processing the crude algae oil to obtain fuels, lubricants, and/or other products.

It is known to be beneficial to thermally-treat the heaviest fraction of fossil petroleum crude, that is, residue from a vacuum distillation column, or, less frequently, the bottom of an atmospheric distillation column. The vacuum residue, also called “bitumen” or “asphalt”, is entirely or substantially 1020° F.+ (that is, it does not boil at 1020° F. true boiling point (TBP)) and contains high non-distillable solids of typically 30 wt-% or higher. The atmospheric bottom is generally 600° F.+ material (does not boil at 600° F. TBP) and contains non-distillable solids of typically 10-20 wt-% or higher. Both the vacuum residue and the atmospheric bottom are highly non-boiling and aromatic (hydrogen-deficient), and do not contain fatty acids, triglycerides, fatty acid esters or associated carbonyl oxygen. It is known to thermally-treat such residue and/or bottom in a coker or visbreaker unit, wherein thermal cracking is conducted in a drum or furnace and/or coil, respectively, wherein such high yields of coke or tar are produced that the drums and coils must be emptied with each batch or cleaned frequently. The high yield of solid coke, which in many conventional thermal units is greater than the yield of oil, results mainly from condensation of the residue and/or the bottom aromatic compounds into coke. For example, conventional thermal units may yield 50 wt-% or more solid coke and less than 50 wt-% oil plus gasses. A delayed coker, for example, may produce as much as about 70-80 wt-% solid coke and about 20 wt-% or less oil plus gasses from a vacuum residue feedstock.

Based on the wide boiling range of the crude algae oils of this disclosure (including naphtha and distillate fractions), and its surprisingly-wide range of compounds (including many aliphatic compounds, fatty acids, and other oxygen-containing compounds), crude algae oil conventionally would not be considered a candidate for coking or visbreaking. The disclosers have found, however, that by thermally-treating the crude algae oil, surprising results are obtained that may improve downstream (subsequent) processes, including extending catalyst lives, improving product quality, and an improved product slate. In certain embodiments, the surprising results include achieving high yields of oils having desirable characteristics including lower coke-precursor content, and achieving desirable conversion to lower boiling oil fractions without the excessive loss of oil to light ends and gasses. Thus, users of many of the embodiments of the disclosure may adjust temperature, holding time, and/or pressure, each within a wide range, to customize boiling range and saturation of the resulting renewable oil, while still producing a pourable and transportable, low-oxygen-containing, clean renewable oil (for example, algae oil) that can be further upgraded in catalytic units without undesirable catalyst deactivation.

Thermal treatment is believed to be especially important for certain complex algae oils of this disclosure, and fractions thereof, the compositions of which are significantly different from those of high-triglyceride vegetable and/or plant oils and typical petroleum crudes. In addition, there may be advantages in some embodiments to thermally-treating algae oil after certain embodiments of pre-treatment, distillation and/or fractionation, or other processing and/or refining and/or upgrading.

Thermal treatment of one or more renewable oils, and improved renewable oils resulting from the treatment, are included in this disclosure. One or more renewable oils or a fraction thereof, treated in certain embodiments of the disclosure are obtained from a biomass, or a material including a substantial amount of the biomass, that is alive or that has been alive within the last 50 years.

Certain embodiments of this disclosure comprise thermal treatment of algae oils, which has been found to improve the quality and boiling range distribution of the oil product from the thermal treatment, and reduce the tendency of the oil product to deactivate catalysts in downstream refinery processes. Thermal treatment may be performed on crude algae oil (or a fraction thereof) and/or on an algae oil (or a fraction thereof) that has been upgraded to some extent by one or more pre-treatment and/or refining processes before the thermal treating, wherein a resulting thermally-treated oil or fraction thereof may be fed to subsequent upgrading.

Included in this disclosure is the thermal treatment of one or more fractions of crude algae oil or any algae-derived oil. Thermal treatment of the one or more fractions is expected to improve the quality and shift the boiling range distribution of the oil product, which may also reduce the tendency of the oil product to deactivate catalysts in downstream (subsequent) refinery processes due to the decreased presence of metals, polycyclic aromatic hydrocarbons (PAHs) and/or heavy compounds that are likely to deactivate the catalyst.

Catalyst deactivation may comprise, for example, inactivating the active sites of the catalyst (typically called “poisoning”, which may be irreversible). Catalyst deactivation may also or instead comprise covering surfaces and/or plugging pores that are intended to enhance contact of oil feedstocks with the active sites (typically called “coking”, which may be at least partially reversible by regeneration).

While many of the catalyst-deactivating compounds are believed to be in the heavy fraction of the crude algae oil, for example, 1020° F.+ (residuum), it is believed that poisons and deactivating compounds may also be found in the lighter fractions of crude algae oil and especially in the distillate fractions (400-600° F., for example). Therefore, thermal treatment is disclosed for the crude algae oil (the whole algae oil) and also for any fraction or combination of fractions of the crude algae oil. As a non-limiting example, the crude algae oil may be fractionated, and the 1020° F.+ may be thermally-treated. Another non-limiting example is, both the 1020° F.+ and 1020° F.⁻ material may be thermally-treated but at different conditions. Severe thermal treating of the whole algae is expected to lower yields and to increase aromaticity of the oil product, and so fractionation, followed by thermal treatment of selected fraction(s) at one or more severities, may allow optimization that balances removal of deactivating-compounds, including poisons and coke-precursors, with yields and oil quality.

Thermal treatment methods according to certain embodiments remove, amongst other things, oxygen by thermal means alone and without the need for hydrogen, for hydrogen and a catalyst, or for an incondensable gas and a catalyst. Exemplary incondensable gasses are hydrogen, carbon monoxide, and inert gases.

Thermal treatment methods according to certain embodiments reduce the boiling point range of algae oil, making them more volatile and less viscous, and consequently benefiting shipping and further upgrading processes and benefiting product slates that value naphtha and distillate.

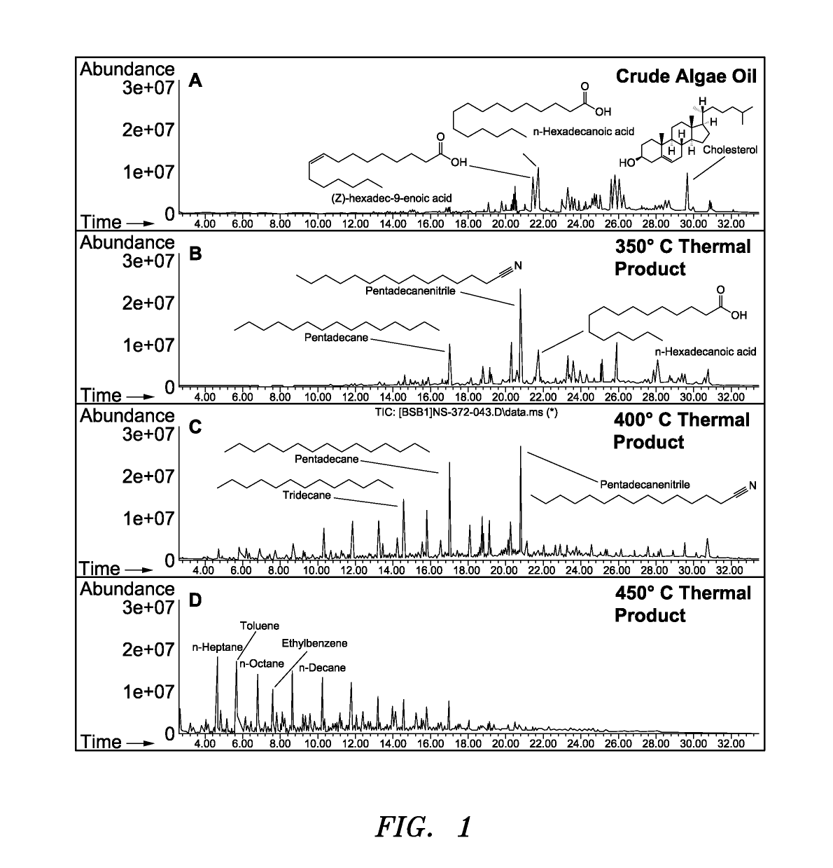

A reduced boiling point distribution of thermally-treated algae oil is shown in panels B, C, and D of FIG. 1 as compared to a crude algae oil (Panel A), as a shift of the peaks to the left with the composition shifting to lower boiling points.

A “reduced boiling point distribution” is also described throughout the disclosure as a shift to distillate- and/or naptha-boiling range fractions, a conversion of the crude algae oil to a lower boiling oil fractions(s), a shift in the boiling range distribution, or a reduction in the boiling point range.

Thermal treatment methods according to certain embodiments decrease acidity of the oil, which may benefit metallurgy requirements for process units. Thermal treatment methods according to certain embodiments remove compounds and/or metals from the oil that are prone to cause catalyst deactivation in downstream refining units: therefore, thermal treatment methods may benefit catalyst loading and/or regeneration requirements and may allow algae oil to be fed to refinery units that could not otherwise accept algae oil. Some or all of these improvements are expected to have beneficial cost effects throughout algae oil handling and refining processes.

Certain embodiments comprise heating crude algae oil or a fraction thereof to a temperature above 300° C. in a batch process, semi-batch, or a continuous process. Thermal treatment equipment may comprise, but is not limited to various types of vessels, for example, a drum, a coil, a conduit, a tank, a pipe, a furnace, a reactor; and a pre-heating system.

The temperature may be raised steadily to a maximum temperature, or ramped according to various schedules to the maximum temperature, with or without mixing of the crude algae oil, and with or without flowing of the crude algae oil through piping or multiple vessels or vessel zones. Certain embodiments comprise heating the crude algae oil to a maximum temperature in the range of 300-600° C., and more typically, in the range of 340-500° C. Certain embodiments comprise maintaining or holding the algae oil at or close to the maximum temperature for a period of time equal to 0 hours (no bold time) up to several hours. For example, 0.05 hour-24 hours may be effective, or more typically, 0.05 hour-8 hours, with the shorter time periods being more likely at higher temperatures and the longer time periods being more likely at lower temperatures. Other non-limiting examples of ranges of holding times are 0 to 10 hours, 0.5 hour to 2 hours, and 0.5 hour to 1 hour. Convenient holding times, or temperature ramping times, are less than 8 hours in a typical batch process setting, for example, equal to or less than an 8 hour work-shift. For example, many convenient holding times at temperature in a continuous process are on the order of 0.1 hour-1 hour. The holding time may also be a function of the heating schedule, for example, a holding time at the maximum temperature may be unnecessary or less important if the heating schedule to the maximum temperature is slow, such as a heating schedule that takes several hours.

Any one or more of the maximum temperature, or heating schedule, or holding time and space velocity are expected to affect the yields of liquid oil (also “oil product”), gas, and solids, the quality and composition of the oil product, and the boiling range shift in the oil product. As will be described in more detail below, higher severity in some or all of the operating conditions of maximum temperature, or heating schedule, or holding time and space velocity will tend to produce higher yields of solids and a greater boiling range shift in the oil product. Higher severity in some or all of these operating conditions will tend to produce higher yields of gasses and solids (coke and/or carbonaceous material and metals), at the expense of oil yield, and the oil will be more aromatic. Therefore, as disclosed above, severity should be optimized for a given crude algae oil or fraction thereof, to achieve the desirable results without over-processing the crude algae oil and/or fraction.

After heating, cooling may be performed naturally during a waiting period or subsequent handling or transport of the thermally-treated algae oil, due to the ambient temperature being less than the maximum temperature. Alternatively, cooling equipment, such as heat exchangers, may be used to hasten the process. If subsequent processing is done immediately or soon after the thermal treatment, the thermally-treated algae oil may flow or be transported to the subsequent processing while still at a temperature above the ambient temperature.

The pressure in a vessel, for example, a reactor, is expected to result mainly or entirely from gasses and light hydrocarbons produced from the thermal treatment of the algae oil components, or autogenous pressure. For example, 300 psig-3000 psig is expected for many embodiments of the disclosure that are performed in a closed vessel or other closed system, with the lower end of the range being typical in lower temperature treatments, such as 300-350° C., and the higher end of the range being typical in higher temperature treatments, such as 450-600° C. Other non-limiting examples of pressure are 0-1000 psig, 0-100 psig, and 0-300 psig. The pressure that builds inside the vessel, for example, a reactor, may be dependent upon the characteristics of the algae oil used, but is expected to mainly be a function of the thermal treatment maximum temperature.

As a non-limiting example, a continuous flow system may be used, wherein the algae crude oil or fraction thereof flows through one or more vessels, either having already been heated to the maximum temperature at the inlet of the vessel(s) or being heated within the vessel(s). In such embodiments, residence time (holding time) could be set by selecting a crude algae flow rate, vessel dimensions, and heating scheme to provide appropriate time at temperature. In a continuous flow system, it is possible to operate many embodiments of the disclosure at a wide range of pressures, for example, at or close to atmospheric pressure, or at higher pressures up to about 3000 psig. Therefore, pressure levels of 0-3000 psig may be effective for continuous flow systems. More typically, however, continuous flow systems will be designed for pressures of less than 1000 psig, and more likely 0-300 or 0-100 psig, due to the cost of metallurgy and equipment for operation at higher pressures.

A once-through flowscheme, with no recycling of oil or gasses, may be used, with the separation of products accomplished downstream of the thermal treatment vessel in one or more conventional separation vessels. In such a once-through flowscheme, the gasses and other thermal products would not be held in a closed vessel, and pressure control would be accomplished by downstream separator pressure control.

While the disclosed embodiments require no hydrogen or other gas to be added or recycled to the thermal treatment vessel, certain embodiments may utilize inert gas or other fluid stream(s) as desired for improvement of processing or oil handling. For example, a nitrogen purge, CO₂-containing stream, or other purge gas, and/or an oil fraction from various sources, including but not limited to algae oil fractions, may be added to the crude algae oil or algae oil fraction for thermal treatment The vessel in which the thermal treatment is conducted may be operatively connected to such an inert gas system, CO₂ gas system, or light ends and/or hydrogen system(s), for example, for subsequent treatment of the light ends and gasses produced during the thermal treatment. For example, oxygen removed from the algal oil during the thermal treatment may exit the process vessel as CO₂, which may be piped to algae-growing facilities for use in algae production.

Methods of thermally treating a crude algae oil, which may be embodied in relatively simple and economical equipment and processing steps, may be called “preparation” of crude algae oil or fraction thereof (for upgrading in subsequent processes), due to these methods being, for example, the first steps, or one of the early steps, after extraction of oil from algae, in upgrading the crude algae. The thermal treatment methods disclosed herein result in improved algae oil properties, which include, but are not limited to, one or more of the following:

a. oxygen and sulfur removal without the addition of hydrogen and/or a catalyst:
b. free fatty acid reduction; total acidity of oil (TAN) reduction:
c. carbon chain length reduction, boiling point (BP) reduction and viscosity and/or density reduction:
d. an increase in saturated hydrocarbons;
e. generation of CO₂;
f. generation of hydrogen and light hydrocarbon gasses; and/or
g. reduction of coke-precursors and/or metals by producing solids in the process.

These improved properties are expected to result in, but are not limited to, one or more of the following benefits:

a. less use of hydrogen;
b. less use of metallurgy compounds;
c. improved and lower-cost transportation of the thermally-treated algae oil;
d. a carbon chain length and saturation of the improved algae oil that may be desirable for inclusion or processing into a particular refinery product, such as jet fuel;
e. CO₂, hydrogen, and light hydrocarbon production, as a result of the thermal treatment, that are possible feeds for chemical or energy production plants;
f. lower catalyst deactivation rates in downstream (subsequent) processes;
g. possible reduction of downstream unit process severity and/or of the total number of process units required to upgrade crude algae oil to a finished fuel and/or overall increased compatibility with existing refineries;
h. “customizing” of algae oil to better match particular fossil petroleum crude oils for improved compatibility with particular refineries designed and operated for those petroleum crude oils; and/or
i. increased options for pre-treatment locations (prior to transport of crude algae oil to a refinery), including the option of locating crude algae oil pre-treatment at the site of algae and/or biomass-growing and extraction facilities.

Ultimately, certain embodiments of the disclosure may, lower capital investment, lower handling and transportation cost, and lower operating costs including catalyst and turnaround costs, and, thus, may help bring renewable algae oil to the fuels market sooner and more profitably.

The improved algae oil chemical and physical characteristics, afforded by the thermal treatment methods of the disclosure, may result in oils well-suited for conventional transportation methods and existing refineries and catalysts. Further, the control over these characteristics, afforded by certain thermal treatment methods of the disclosure, is expected to allow an algae oil producer or buyer to adjust the methods to customize the algae oil for individual refineries. For example, by adjusting temperature and/or time at temperature, algae oil characteristics may be obtained that are consistent with, or close to, those of a particular petroleum feedstock. For example, if a refinery was designed or revamped to run a particular crude oil, for example, a Venezuelan crude oil, an algae oil feedstock (or a fraction thereof) may be produced according to certain embodiments to exhibit boiling point, saturation, catalyst deactivation rates, and/or other characteristics in a range close to the characteristics of that Venezuelan crude, and/or of a fraction of that crude or a product of that crude. For example, a Venezuelan crude (or a fraction thereof) may have a particular boiling point range and distribution, and a crude algae oil (or a fraction thereof) may be thermally-treated under conditions chosen to “customize” the algae oil to provide the largest percentage of compounds with a carbon chain length to match or come close to the carbon chain length, boiling point range (boiling point distribution) of the Venezuelan crude oil and/or fraction. In addition or instead, a crude algae oil or a fraction thereof may be thermally-treated to cause catalyst deactivation rates that match or are less than the “target” (for example, Venezuelan) crude oil and/or fraction, to lessen the effect of the algae oil and/or fraction on a catalytic unit designed for the target crude oil and/or fraction. For another example, if a refinery was designed and/or revamped to run a particular crude oil, for example, Saudi Arabian light blended with another particular crude, algae oil feedstock may be produced according to certain embodiments to exhibit boiling point, saturation, catalyst deactivation rates, and/or other characteristics in a range close to the characteristics of that crude blend, and/or of a fraction of that crude blend or a product of that crude blend. Typically, the “customized” thermally-treated algae oil would have lower sulfur content compared to the petroleum crude or crude fraction, which could be an advantage to feeding or co-feeding algae oil in a conventional petroleum refinery. The ability to customize algae oil thermal treatment, and, hence, the thermal products, may enable thermally-treated algae oil to be fed to process units of a refinery either as a sole feedstock or blended with the refinery's typical crude oil, crude fractions and/or other feedstock typical for that unit. Or, the thermally-treated algae oil may be a supplement to blend with other feedstocks that are typically less preferred by the particular refiner, but wherein the resulting blend has characteristics like the feedstocks for which the refinery process unit(s) were originally designed or revamped.

Customizing may be done, for example, by linear programming to create blends of algae oil, produced at different thermal treatment conditions, for matching to target compositions. One approach would be to create a database of thermal algae oil products vs. temperature, residence time, and pressure conditions, and then to linearly blend the products to the desired target fossil crude oil composition.

The renewable crude oils (for example, algae oils or algae-derived oils) of this disclosure may be obtained or extracted by various means from biomass that has been alive within the last 50 years. The renewable crude oil may be obtained or extracted by various means from naturally-occurring non-vascular photosynthetic organisms and/or from genetically-modified non-vascular photosynthetic organisms. Genetically modified non-vascular photosynthetic organisms can be, for example, where the chloroplast and/or nuclear genome of an algae is transformed with a gene(s) of interest. As used herein, the term non-vascular photosynthetic organism includes, but is not limited to, algae, which may be macroalgae and/or microalgae. The term microalgae includes, for example, microalgae (such as Nannochloropsis sp.), cyanobacteria (blue-green algae), diatoms, and dinoflaggellates. Crude algae oil may be obtained from the naturally-occurring or genetically-modified algae wherein growing conditions (for example, nutrient levels, light, or the salinity of the media) are controlled or altered to obtain a desired phenotype, or to obtain a certain lipid composition or lipid panel.

In certain embodiments of this disclosure, the biomass is substantially algae, for example, over 80 wt % algae, or over 90 wt % algae, or 95-100 wt % algae (dry weight). In the Examples of this disclosure, the algae oil feedstock is obtained from biomass that is photosynthetic algae grown in light. Other embodiments, however, may comprise obtaining algae biomass or other “host organisms” that are grown in the absence of light. For example, in some instances, the host organisms may be a photosynthetic organism grown in the dark or an organism that is genetically modified in such a way that the organism's photosynthetic capability is diminished or destroyed. In such growth conditions, where a host organism is not capable of photosynthesis (e.g., because of the absence of light and/or genetic modification), typically, the organism will be provided with the necessary nutrients to support growth in the absence of photosynthesis. For example, a culture medium in which an organism is grown, may be supplemented with any required nutrient, including an organic carbon source, nitrogen source, phosphorous source, vitamins, metals, lipids, nucleic acids, micronutrients, and/or an organism-specific requirement. Organic carbon sources include any source of carbon which the host organism is able to metabolize including, but not limited to, acetate, simple carbohydrates (e.g., glucose, sucrose, and lactose), complex carbohydrates (e.g., starch and glycogen), proteins, and lipids. Not all organisms will be able to sufficiently metabolize a particular nutrient and nutrient mixtures may need to be modified from one organism to another in order to provide the appropriate nutrient mix. One of skill in the art would know how to determine the appropriate nutrient mix.

Several, but not the only, examples of algae from which a suitable crude oil may be obtained are a Chlamydomonas sp., a Dunaliella sp., a Scenedesmus sp., a Desmodesmus sp., a Chlorella sp., a Volvacales sp., a Volvox sp., an Arthrospira sp., a Sprirulina sp., a Bolryococcus sp., a Desmid sp., a Hemalococcus sp., a Nannochloropsis sp. or any combination of one or more species of the above species.

Non-limiting examples of organisms from which suitable a crude oil may be obtained include Chlamydomonas reinhardtii, Dunaliella salina, Haematocccus pluvialis, Nannochloropsis oceania, Nannochloropsis salina, Scenedesmus dimorphus, Spirulina maximus, Arthrospira fusiformis, Dunaliella viridis, Nannochloropsis oculata, or Dunaliella teriolecta, or any combination of one or more species of the above organisms.

Examples of cyanobacteria from which a suitable crude oil may be obtained include Synechococcus sp., Spirulina sp., Synechocystis sp. Athrospira sp., Prochlorococcus sp., Chroococcus sp., Gleoecapsa sp. Aphanocapsa sp., Aphanothece sp., Merismopedia sp., Microcystis sp., Coelosphaerium sp. Prochlorothrix sp. Oscillatoria sp., Trichodesmium sp., Microcoleus sp., Chroococcidiopisis sp., Anabaena sp., Aphanizomenon sp., Cylindrospermopsis sp., Cylindrospermum sp., Tolypothrix sp., Leptolyngbya sp. Lyngbya sp., or Scytonema sp., or any combination of one or more species of the above species.

As discussed above, algae may be macroalgae and/or microalgae and the term microalgae includes, for example, microalgae (such as Nannochloropsis sp.), cyanobacteria (blue-green algae), diatoms, and dinoflaggellates. Therefore the biomass in which the crude algae oil is obtained from can comprise a mixture of one or more of an algae, such as a microalgae and one or more of a cyanobacteria.

While the renewable crude oils of this disclosure may be extracted by various means from naturally-occurring non-vascular photosynthetic organisms and/or from genetically-modified non-vascular photosynthetic organisms, the algae oils of particular interest have been extracted from hydrothermally-treated algae biomass.

For hydrothermal treatment, various solvents may be used, for example, heptanes, hexanes, and/or MIBK. Certain embodiments of the hydrothermal treatment comprise an acidification step. Certain embodiments of the hydrothermal treatment comprise heating (for clarity, here, also called “heating to a first temperature”), cooling, and acidifying the biomass, followed by re-heating and solvent addition, separation of an organic phase and an aqueous phase, and removal of solvent from the organic phase to obtain an oleaginous composition. A pretreatment step optionally may be added prior to the step of heating to the first temperature, wherein the pretreatment step may comprise heating the biomass (typically the biomass and water composition of step (a) below) to a pretreatment temperature (or pretreatment temperature range) that is lower than the first temperature and holding at the pretreatment temperature range for a period of time. The first temperature will typically be in a range of between about 250° C. and about 360° C., as illustrated by step (b) listed below, and the pretreatment temperature will typically be in the range of between about 80° C. and about 220° C. In certain embodiments the holding time at the pretreatment temperature range may be between about 5 minutes and about 60 minutes, or about 10 minutes to about 50 minutes. Other exemplary holding times are about 10 minutes, about 15 minutes, about 20 minutes, about 25 minutes, about 30 minutes, about 35 minutes, about 40 minutes, about 45 minutes, or about 50 minutes. In certain embodiments, acid may be added during the pretreatment step, for example, to reach a biomass-water composition pH in the range of about 3 to about 6.

The hydrothermal extraction methods used for the algae oil feed embodiments detailed in the Examples of this document were extracted from algae biomass by the processes described in U.S. Patent Application Ser. No. 61/367,763, filed Jul. 26, 2010 and Ser. No. 61/432,006, filed Jan. 12, 2011 (both incorporated herein). Extraction processed are also described in U.S. Ser. No. 13/191,373, filed Jul. 26, 2011, U.S. Ser. No. 13/479,611, filed May 24, 2012, U.S. Ser. No. 13/356,830, filed Jan. 24, 2012, and U.S. Ser. No. 13/298,149, filed Nov. 16, 2011 (all of which are incorporated herein). It should be noted that the extraction methods may be conducted as a batch, continuous, or combined process. Any alternative extraction method known to one skilled in the art, or any of the extraction methods described above, can be used to obtain the crude algae oil used in the disclosed methods. Specifically, unless otherwise specified herein, the extraction procedures for the crude algae oils of the Examples were:

a) obtaining an aqueous composition comprising said biomass and water,
b) heating the aqueous composition in a closed reaction vessel to a first temperature between about 250° C. and about 360° C. and holding at said first temperature for a time between 0 and 60 minutes;
c) cooling the aqueous composition of (b) to a temperature between ambient temperature and about 150° C.;
d) acidifying the cooled aqueous composition of (c) to a pH from about 3.0 to less than 6.0 to produce an acidified composition;
e) heating the acidified composition of (d) to a second temperature of between about 50° C. and about 150° C. and holding the acidified composition at said second temperature for between about 0 and about 30 minutes;
f) adding to the acidified composition of (e) a volume of a solvent approximately equal in volume to the water in said acidified composition to produce a solvent extraction composition, wherein said solvent is sparingly soluble in water, but oleaginous compounds are at least substantially soluble in said solvent;
g) heating the solvent extraction composition in closed reaction vessel to a third temperature of between about 60° C. and about 150° C. and holding at said third temperature for a period of between about 15 minutes and about 45 minutes:
h) separating the solvent extraction composition into at least an organic phase and an aqueous phase;
i) removing the organic phase from said aqueous phase; and
j) removing the solvent from the organic phase to obtain an oleaginous composition.

In the Examples, the algae biomass was derived from Nannochloropsis salina algae grown in light, and temperature and holding time for step (b) above was 260° C. and 60 minutes, pH of step (d) above was 4, and the solvent was mixed heptanes. The temperatures and/or hold times of the other steps were in the ranges mentioned above. No flocculation step was performed.

The oleaginous composition obtained from the above steps was the “crude algae oil” used as feedstock for the example thermal treatment experiments described herein. “Crude algae oil” in this disclosure, also called “full boiling range crude algae oil”, is the whole, unfractionated, algae oil obtained from biomass. The characteristics and compositions of certain crude algae oils of this disclosure, including crude algae oils extracted from hydrothermally-treated Nannochloropsis sp. and from other algae strains, are described in detail in Provisional Application Ser. No. 61/521,687, filed on Aug. 9, 2011, which is incorporated herein by this reference.

The crude algae oils of this disclosure have been analyzed by current state-of-the art simulated distillation (SIMDIST) and elemental analysis (EA), and HT GC-MS equipment and methods that are state-of-the-art, or in certain embodiments, advancements over the state of the art. The HT GC-MS equipment and methods are fully described in U.S. Provisional Patent Application Ser. No. 61/547,391, filed Oct. 14, 2011, U.S. Provisional Patent Application Ser. No. 61/616,931, filed Mar. 28, 2012, and U.S. Provisional Patent Application Ser. No. 61/553,128, filed Oct. 28, 2011, (all of which are incorporated herein by reference). These state of the art and advanced analyses provide distillation curves for over about 95 mass percent of the crude algae oil, and compound classes, types and individual compound names for much of the approximately 80-90 mass percent of the crude algae oil that is “fingerprinted” by HT GC-MS, as is further explained below.

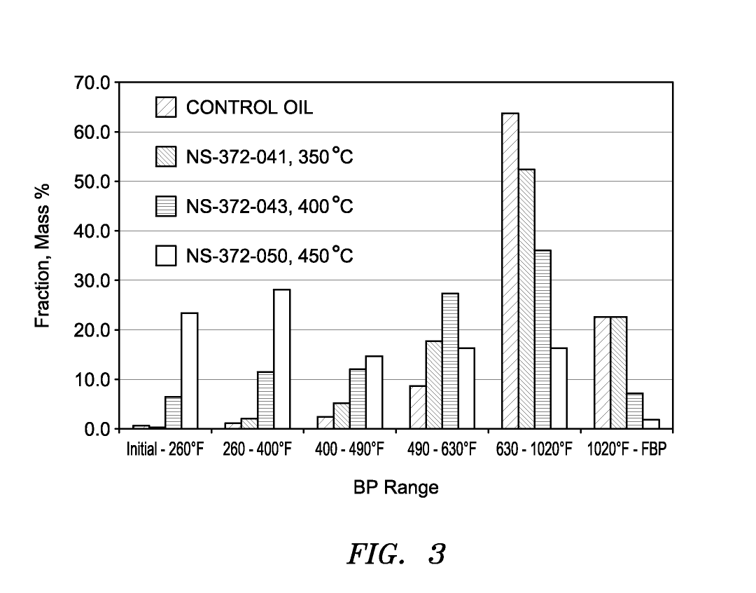

Many of the crude algae oils of this disclosure may be described as having a broad boiling point range, for example, approximately 300-1350° F. true boiling point. It may be noted that the heavy fraction in the boiling point distribution is usually reported as 1020° F.+, as this is a conventional refinery vacuum distillation tower cut-point between “distillable” material and “non-distillable” material. The SIMDIST boiling point curves in Application Ser. No. 61/521,687, however, allow description of the 1020° F.+ material in more detail, for example, by estimating the 1020-1200° F. fraction, the 1200—FBP fraction, and the small portion above the FBP that is “non-detectable” or “non-distillable” even by SIMDIST. From the Application Ser. No. 61/521,687 SIMDIST boiling curves, one may see that certain crude algae oils contain a 1020-1200° F. fraction in the range of about 10-18 mass %, a 1200—FBP fraction in the range of about 8-15 mass %, and a portion that is non-detectable and/or non-distillable by SIMDIST in the range of about 2-5 mass %. Thus, the SIMDIST data in Table 3 and FIG. 3 of this disclosure, and in Application Ser. No. 61/521,687, may be described as including compounds up to about C-100 and having boiling points up to about 1350° F., or, in other words, providing a boiling point curve of percent of (mass fraction) versus temperature of up to about 1350° F. This translates to the SIMDIST equipment and methods used by Applicant as providing data representing over about 95 percent of the material in the crude algae oil, but does not represent the last few percent of the material, for example, about 2-5 mass percent of the material.

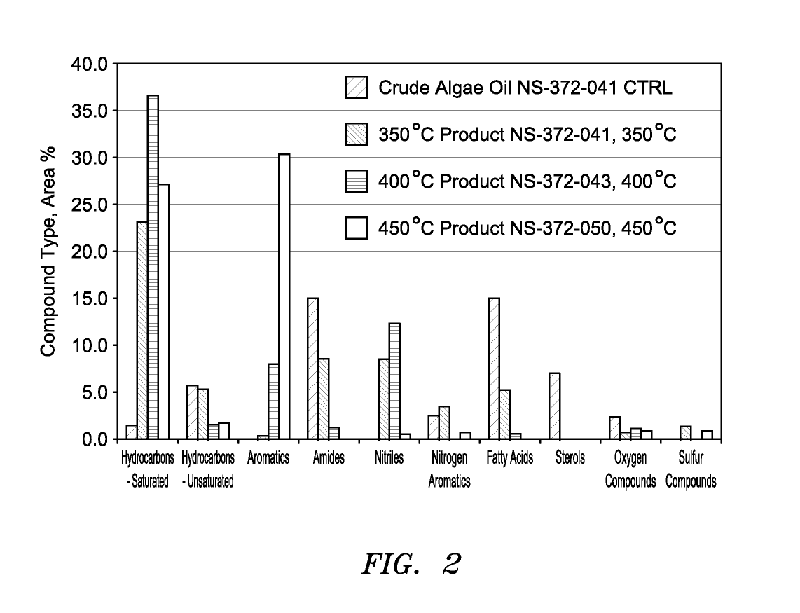

The HT GC-MS procedures and equipment used to obtain the data in Table 5, FIG. 1 and FIG. 2 of this document, and in Application Ser. No. 61/521,687 provide spectral/chromatogram data representing a large portion, but again not all, of the crude algae oil. The HT GC-MS spectral/chromatogram data represents the crude algae oil portion boiling in a range of about IBP—1200° F. or, in other words, the entire crude algae oil except for approximately the 1200—FBP fraction and the non-detectable and/or non-distillable material over the final boiling point. By again referring to the 1200° F. cut point of the SIMDIST curves in Application Ser. No. 61/521,687, one may describe the portion of the crude algae oil represented by the HT GC-MS spectra/chromatogram as about 80-90 mass percent of the crude algae oil.

Of the total peak area of the HT GC-MS chromatograms in this disclosure, including those in Application Ser. No. 61/521,687, about 60 percent of the peak area may be specifically identified and named. This means that the chromatogram is the “fingerprint” of about 80-90 mass percent of the crude algae oil, and about 60 percent of the peak area of that fingerprint may be specifically named and categorized by compound type and/or class.

A complex crude algae oils may, as determined by the above described HT GC-MS analysis methods, comprise few or no triglyceride compounds, less than 10 area % saturated hydrocarbon, less than 10 area % aromatics (aromatic molecules) including some polyaromatic compounds, and many polar compounds including greater than 15 area % fatty acids, sterols, nitrogen compounds (nitrogen-containing compounds), oxygen compounds (oxygen-containing compounds), amides, and nitriles, and many unknowns. This wide range of compound types, including many compounds other than fatty acids, is unexpected in view of the relatively simple, triglyceride oils from vegetables and plants, and is unexpected even in view of the fatty acid moieties that might be obtained from the triglyceride oils. Further, this wide range of compound types is disconcerting to petroleum refiners, as discussed above.

Certain complex crude algae oils of this disclosure, by EA, comprise oxygen content typically greater than 5 wt %, and nitrogen content typically greater than 3 wt %. Crude algae oil hydrogen/carbon mole ratios are typically greater than 1.6, and as high as 1.7-2.1, for example. The oxygen content of these complex crude algae oils may be explained by the many carbonyl groups, mainly due to fatty acids present in the algae oil. A wide range of oxygen content may be seen, for example, 1-35 wt %, but more typically oxygen content is typically 5-35 wt % and more typically 5-15 wt %. The percent oxygen content of the thermally-treated algae oil can be, for example, less than 6%, less than 5%, less than 4%, less than 3%, less than 2%, or less than 1%.

The fatty acid moieties may range, for example, from about 4 to about 30 carbon atoms, but typically 10 to 25 carbon atoms, and even more typically, 16 to 22 carbon atoms. The fatty acid moieties most commonly are saturated or contain 0, 1, 2, 3, or more double bonds (but typically fewer than six). Therefore, one may describe the crude algae oils for most embodiments of the disclosure as containing many long, straight-chain fatty acid moieties, wherein the long straight chains are typically saturated (alkanes) or wherein few of the carbons of the long chains are unsaturated. In addition to the high content of simple fatty acids, for example 15-60 area %, the crude algae oils of this disclosure may also contain some fatty acid esters, sterols, carotenoids, tocopherols, fatty alcohols, terpenes, and other compounds, but typically only a small amount of triglycerides, for example. <1 area %, <0.1 area %, or <0.01 triglycerides.

The crude algae oil of the Examples was not processed or treated between the above extraction process and the thermal processing described in the Examples. For example, the crude algae oil was not hydrotreated, hydrocracked, reformed, filtered, chemically-treated, or fractionated after being extracted and before the thermal treatment. The crude algae oil was not subjected to any RBD processing (the refining, bleaching, and deodorizing process conventionally known and used for many bio-oils), and was not subjected to any of the individual steps of refining, bleaching or deodorizing, after being extracted and before the thermal treatment, or at any time. Certain embodiments of the disclosure remove fatty acids and other gumming and/or fouling oil components, including trace metals (Fe, Ni, etc.) and metalloids (P, etc.), and so accomplish some or all of the goals of RBD. Therefore, certain embodiments of the disclosure reduce or eliminate the need for RBD processing of an algae oil.

In the Examples, the crude algae oil was thermally-treated in a closed vessel at different temperatures, specifically 350° C., 400° C., and 450° C. The algae oil in each experiment was maintained at the target (“maximum”) temperature for approximately one hour, in the closed vessel, without providing any hydrogen or other gas, and without providing any catalyst or additives. Pressure in the vessel increased during each experiment, from the formation of hydrogen, CO₂, and other light compounds including light hydrocarbons, formed by the thermal treatment of the algae oil.

The vessel can be an open or closed vessel. A closed vessel does not allow the release of gases into the atmosphere unless opened up, whereas an open vessel allows the release of at least some of the gasses into the atmosphere. The maximum temperature, for example, can be 350° C. plus or minus 10° C., or plus or minus 20° C. due to temperature fluctuations that may occur. The thermal treatment can occur without the addition of hydrogen, or without the addition of hydrogen and a catalyst, or without the addition of an incondensable gas and a catalyst. The heating step can occur with or without mixing. The start of timing of the holding temperature can begin when the temperature is within plus or minus 10° C. of the desired maximum temperature, or within plus or minus 20° C. of the desired maximum temperature. The holding time can also be minimized while simultaneously the temperature is raised to the maximum temperature.

It should be noted that, for example, other temperatures, pressures, holding times, flowschemes (for example, continuous), algae sources, and modified extraction techniques (for example, a modified hydrothermal treatment) can be used according to certain embodiments of the disclosure with beneficial results, including results and/or trends that are the same or similar as those in the following Examples.

The following examples are intended to provide illustrations of the application of the present disclosure. The following examples are not intended to completely define or otherwise limit the scope of the disclosure. One of skill in the art will appreciate that many other methods known in the art may be substituted in lieu of the ones specifically described or referenced herein.

### EXAMPLES

The crude algal oil included in these Examples are reported under the names crude algal oil, algal crude oil, or control oil. Given the above discussion regarding HT GC-MS analyses, including the disclosure in U.S. Provisional Patent Application Ser. No. 61/547,391, filed Oct. 14, 2011 (incorporated herein), it will be understood that the area percent of a given compound class is the percent, of total area of the chromatogram, identified as being in the given compound class, wherein the total area of the chromatogram is typically representative of about 80-90 mass percent of the crude algae oil.

Three experiments were conducted using the crude algae oil described above, in a commercially-available Parr™ reactor. After providing the crude algae oil in the reactor and purging the reactor with nitrogen, the reactor remained closed with no bleeding or gasses or other flow of material into or out of the reactor until the end of each experiment. The three experiments were conducted as follows:

### Example 1

### Thermal Treatment at 350° C.

1. Determine the weight of 150 mL of oil (crude algae oil). Add 150 mL of oil to the 500 mL Parr reactor and mix.
2. Purge the Parr reactor with nitrogen gas.
3. Heat and mix for 60 minutes at 350° C. (Begin timing when temperature is above 345° C.). Ramp temperature at high heat to shorten the heat up time. Mix at 100 rpm. Record pressure vs. time and temperature.
4. Cool Parr reactor. Wait five minutes after temperature is cooled to 40° C., then record gas pressure.
5. Cool reactor to room temperature. Open reactor and vent gases in fume hood.
6. Collect oil from reactor. Determine oil amount (weight and volume).
7. Add enough Chloroform to Parr reactor to dissolve residue potentially remaining in the reactor. Remove the solvent with rotovap. Determine amount (weight) of residue (“solids” in Table 1).

### Example 2

### Thermal Treatment at 400° C.

1. Determine the weight of 150 mL of oil. Add 150 mL of oil to the 500 mL Parr reactor and mix.
2. Purge the Parr reactor with nitrogen gas.
3. Heat and mix for 60 minutes at 400° C. (Begin timing when temperature is above 395° C.). Ramp temperature at high heat to shorten the heat up time. Mix at 100 rpm. Record pressure vs. time and temperature.
4. Cool Parr reactor. Wait five minutes after temperature is cooled to 40° C., then record gas pressure.
5. Cool reactor to room temperature. Open reactor and vent gases in fume hood.
6. Collect oil from reactor. Determine oil amount (weight and volume).
7. Add enough Chloroform to Parr reactor to dissolve residue potentially remaining in the reactor. Remove the solvent with rotovap. Determine amount (weight) of residue (“solids” in Table 1).

### Example 3

### Thermal Treatment at 450° C.

1. Determine the weight of 150 mL of oil. Add 150 mL of oil to the 500 mL Parr reactor and mix.
2. Purge the Parr reactor with nitrogen gas.
3. Heat and mix for 60 minutes at 450° C. (Begin timing when temperature is above 445° C.). Ramp temperature at high heat to shorten the heat up time. Mix at 100 rpm. Record pressure vs. time and temperature.
4. Cool Parr reactor. Wait five minutes after temperature is cooled to 40° C., then record gas pressure.
5. Cool reactor to room temperature. Open reactor and vent gases in fume hood.
6. Collect oil from reactor. Determine oil amount (weight and volume).
7. Add enough Chloroform to Parr reactor to dissolve residue potentially remaining in the reactor. Remove the solvent with rotovap. Determine amount (weight) of residue (“solids” in Table 1).

The oil products of the three experiments discussed herein and detailed in Tables 1-5, and FIGS. 1-3, are the oils resulting from the experiments, after the gasses are vented in the fume hood (see steps 5 and 6, above). Thus, the products and yields from the experiments may be described as oil (“liquid oil” or “oil product” or “thermal product”), solids (for example, carbonaceous material or “coke” comprising metals), and gasses. The distillation information in Table 3 (shown below), therefore, is the Simulated Distillation of the crude algae oil and each “whole” oil product, that is, each oil from step 6 without any fractionation cuts being taken prior to the Simulated Distillation.

Table 1 summarizes the wt % yield of oil, solids, and gases at the different temperatures. The oil wt % yield ranged from 86.6, to 81.9, and 40.9% for the 350° C., 400° C., and 450° C. temperature values, respectively. The formation of solids (0.4, 8.1, 19.3%) and gases (2.6, 6.3, 18.3%) increased as the temperature increased.

TABLE 1

| ID | Temperature | Oil | Solids | Gas | Losses | Pmax |
|---|---|---|---|---|---|---|
| for Ext. Analysis | (° C.) | % | % | % | % | (psi) |
| NS-372-041, | 350 | 86.6 | 0.4 | 2.6 | 10.4 | 460 |
| 350° C. | | | | | | |
| NS-372-043, | 400 | 81.9 | 8.1 | 6.3 | 3.7 | 610 |
| 400° C. | | | | | | |
| NS-372-050, | 450 | 40.9 | 19.3 | 18.3 | 21.4 | 2910 |
| 450° C. | | | | | | |

Table 2 contains the C, H, N, S, and O wt % elemental composition for the algae oil, the three thermal products, and representative Jet Fuel and HVGO samples for comparison. The total nitrogen content was not affected by the thermal treatment, but the total amount of oxygen was dramatically reduced from 5.7% in the crude algae oil to 0.2% in the 400° C. sample and 1.5% in the 450° C. thermal product. Therefore, it may be seen that thermal treatment leads to considerable reduction of the total oxygen content by decomposing the fatty acids in the crude algae oil, reducing the total acidity of the oil, and producing CO₂, which can be captured and used for the growth of algae. The oxygen reduction in these and certain other embodiments may be described as at least about a 50% reduction of oxygen (wt % by EA), or in the range of at least about a 67% reduction of oxygen, up to at least about a 90% reduction of oxygen (wt % by EA), or in the range of about a 67% reduction of oxygen up to about a 100% reduction of oxygen (wt % by EA).

The heating value, as determined by the Dulong equation, is also positively affected by the reduction of the oxygen in the thermal products. Also, the density of the oil decreases, having beneficial effects on oil fluidity and enabling transportation through pipelines. For example, one may see in Table 2 that the thermal product treated at 350° C. was slightly less dense than the crude algae oil, the thermal product treated at 400° C. was about 0.5 g/mL less dense than the crude algae oil (about 5% less dense at 22.8° C.), and the thermal product treated at 450° C. was about 0.8 g/mL less dense (about 8% less dense at 22.8° C.) than the crude algae oil. Certain embodiments of the thermal treatment method may be described as reducing the density of a crude algae oil by at least about 5%, by at least 10%, by about 2 percent up to about 10 percent, or by about 5 percent up to about 20 percent, for example. Other embodiments of the thermal treatment may be described as reducing the density of a crude algae such that the thermally-treated algae oil is 2 to 5 percent less dense, 5-8 percent less dense, 8-11 percent less dense, 9-12 percent less dense, 12-30 percent less dense, 30-50 percent less dense, 50-80 percent less dense, 80-100 percent less dense, at least 100 percent less dense, at least 150 percent less dense, or at least 200 percent less dense than the crude algae oil.

Gravity of the oil can be measured, for example, by the American Petroleum Institute (API) Gravity formula: API=(141.5/SG)−131.5, where API=Degrees API Gravity and SG=Specific Gravity (at 60° F.). Specific Gravity (at 60° F.) (141.5/API gravity)+131.5.

TABLE 2

| | | | | | | Heating | Density |
|---|---|---|---|---|---|---|---|
| | | | | % | % | Value | (g/mL) |
| Sample ID | % C | % H | % N | S | O* | (MJ/Kg)* | 22.8° C. |
| Algae Crude Oil | 77.7 | 11.7 | 4.2 | 0.6 | 5.7 | 42 | 0.9612 |
| NS-372-041, | 80.8 | 11.6 | 4.3 | 0.4 | 2.9 | 44 | 0.9567 |
| 350° C. | | | | | | | |
| NS-372-043, | 83.6 | 11.7 | 4.2 | 0.4 | 0.2 | 45 | 0.9164 |
| 400° C. | | | | | | | |
| NS-372-050, | 84.0 | 10.1 | 4.2 | 0.1 | 1.6 | 43 | 0.8780 |
| 450° C. | | | | | | | |
| Jet Fuel | 86.2 | 12.3 | 0.5 | 0.0 | 0.0 | 47 | 0.8293 |
| HVGO | 86.0 | 10.7 | 0.0 | 2.3 | 0.0 | 45 | 0.9670 |

The thermal treatment effects on the boiling point distribution are given in Table 3, which contains the simulated distillation fraction mass % of the control (feed) crude algae oil and the three thermal products.

TABLE 3

| AVERAGED | | | | | | |
|---|---|---|---|---|---|---|
| DATA | FRACTION MASS % | | | | | |
| Sample ID | Initial-260° F. | 260-400° F. | 400-490° F. | 490-630° F. | 630-1020° F. | 1020° F. FBP |
| CONTROL OIL | 0.8 | 1.2 | 2.5 | 8.8 | 64.0 | 227 |
| NS-372-041, | 0.0 | 2.1 | 5.2 | 17.8 | 52.3 | 22.5 |
| 350° C. | | | | | | |
| NS-372-043, | 6.5 | 11.4 | 12.0 | 27.2 | 36.0 | 7.0 |
| 400° C. | | | | | | |
| NS-372-050, | 23.3 | 28.0 | 14.5 | 16.1 | 16.5 | 1.7 |
| 450° C. | | | | | | |

FIG. 3 shows the corresponding plot of the data. The majority of the crude algae oil boils in the 630-1020° F. (approximately 332° C.-549° C.) range. Increasing the temperature shifts the boiling point distribution to lower boiling points. At 350° C., the 490-630° F. (approximately 254° C.-332° C.) fraction increases to 17.8% from 8.8%. At 400° C. the same boiling point fraction increases to 27.2% and the 630-1020° F. (approximately 332° C.-549° C.) fraction decreases to 36.0%. At 450° C., the initial-260° F. and 260-400° F. ranges become the most abundant with 23.3 and 28.0% fraction mass respectively, in comparison to the original crude algae oil fractions of 0.8 and 1.2%. Increasing the thermal treatment temperature has beneficial effects on the crude algae oil by decreasing the boiling point distribution, and making it a lighter crude oil. This trend is also confirmed by the density values for the algae crude oil and the thermal products, as reported in Table 2. While the crude algae oil has a density of 0.9612 g/ml at 22.8° C., the thermal oil products exhibit lower densities, specifically, 0.9567 g/ml for the 350° C. thermal treatment, 0.9164 for the 400° C. thermal treatment, and 0.8780 g/ml for the 450° C. thermal treatment. One may compare the thermal products with the jet fuel and HVGO (heavy vacuum gas oil) examples in Table 2. While the algae crude oil density is nearly the same as the HVGO density, the densities of the three thermal products fall between the HVGO and the jet fuel densities and are significantly lower than the HVGO density. Thermal treatment may therefore be seen to result in lighter oils of lower densities, which flow and pour easily.

In Table 2, density is reported, rather than viscosity. This is done because the thermal products from thermal treatment of the algae oil are liquid, rather than solid or semi-fluid, at room temperature and so laboratory viscosity measurements are not applicable. It should be noted that all three oils, produced from thermal treatment at the three temperatures, were easy to pour, and that the density of these thermal products may be used as an indicator of increased pourability and lightness, and reduced viscosity, relative to the crude algae oil.

Trace inductively-coupled plasma mass spectrometry (ICPMS) analysis data for the oils are given in Table 4, in ppm. Most elements, including Phosphorus (P), Sulfur (S), Iron (Fe), Nickel (Ni), and Zinc (Zn), are reduced as the thermal treatment temperature increases. This reduction of metals is expected to benefit downstream processing, for example, by reducing catalyst consumption due to reduced processing requirements (the thermal treatment already having lowered/removed these metals) and/or due to reduced metal poisoning of the catalyst. Certain embodiments may be described as reducing iron content by about 50 up to about 99 percent, or about 60 up to about 80 percent, for example. Certain embodiments may be described as reducing phosphorus by about 50 up to about 99 percent, or about 50 percent up to about 90 percent, for example. Also, as mentioned above, certain embodiments of the disclosed thermal treatment methods may reduce or eliminate the need for RBD processing of algae oil or other bio-oils containing fatty acids/triglycerides and oxygen.

Table 4 shows trace metal analysis (ppm) of crude algae oil and thermal treatment products.

| | NS-372-041A | | | |
|---|---|---|---|---|
| | (control oil) | NS-372-041B | NS-372-043 | NS-372-050 |
| | Crude Algae Oil | 350° C. | 400° C. | 450° C. |
| B | <10 | <10 | <10 | <10 |
| Al | <10 | <10 | <10 | <10 |
| Si | 33 | 33 | 32 | 34 |
| P | 27 | 13 | <5 | <5 |
| S | 3846 | 1764 | 1512 | 1092 |
| Cr-52 | <1 | 2 | 2 | <1 |
| Cr-53 | 8 | 9 | 8 | 7 |
| Mn | <1 | <1 | <1 | <1 |
| Fe | 399 | 481 | 85 | 13 |
| Ni | 29 | 42 | 22 | <10 |
| Cu-63 | 14 | 12 | <10 | <10 |
| Cu-65 | <10 | <10 | <10 | <10 |
| Zn-66 | 46 | 30 | <10 | <10 |
| Zn 68 | 45 | 30 | <10 | <10 |
| Sr | <10 | <10 | <10 | <10 |
| Sn | <10 | <10 | <10 | <10 |
| Sb | <10 | <10 | <10 | <10 |
| Pb | <10 | <10 | <10 | <10 |

FIG. 1 shows the HT-GCMS charts for the crude algae oil and the three thermal products. It can be seen that the boiling point distribution decreases as the temperature increases. The particular molecular changes due to thermal treatment are elucidated using HT-GCMS. As the temperature increases, the concentration of acids in the spectra decreases and the concentration of alkanes increases. Also, amides are converted to nitriles. As may be seen in FIG. 1, temperature has a very important effect on the molecular nature of the compounds in the algae oil.

Table 5 contains the breakdown summaries of the different compounds in the four samples, in chromatographic peak area %. The balance of the compounds not categorized in Table 5, that is, 100% minus the sum of the percentages listed for each oil in Table 5, corresponds to the “unknown” peaks in the chromatogram, that is, compounds “seen” by the HT GC-MS but not identified.

Table 5 shows the breakdown of chemical compound types (Area %) in algae crude oil (Nannochloropsis salina) and its thermally treatment products.

| | Crude Algae Oil | 350° C. Product | 400° C. Product | 450° C. Product |
|---|---|---|---|---|
| | NS-372-041 | NS-372-041, | NS-372-043, | NS-372-050, |
| | CTRL | 350° C. | 400° C. | 450° C. |
| Hydrocarbons - | 1.5 | 23.2 | 36.6 | 27.2 |
| Saturated | | | | |
| Hydrocarbons - | 5.8 | 5.4 | 1.5 | 1.8 |
| Unsaturated | | | | |
| Aromatics | 0.0 | 0.3 | 8.0 | 30.3 |
| Amides | 14.9 | 8.5 | 1.2 | 0.0 |
| Nitriles | 0.0 | 8.4 | 12.3 | 0.5 |
| Nitrogen Aromatics | 2.5 | 3.5 | 0.0 | 0.6 |
| Fatty Acids | 14.8 | 5.2 | 0.6 | 0.0 |
| Sterols | 7.0 | 0.0 | 0.0 | 0.0 |
| Oxygen Compounds | 2.4 | 0.7 | 1.0 | 0.8 |
| Sulfur Compounds | 0.0 | 1.4 | 0.0 | 0.8 |

FIG. 2 is the corresponding plot of the compounds types from the HT-GCMS data. Most importantly, the total amount of saturated compounds (e.g., n-alkanes) increases as a function of temperature whereas the amounts of fatty acids decrease. This is consistent with the mechanism of decarboxylation. At 400° C. the total amount of acids is eliminated and the saturated hydrocarbons are maximized. Certain embodiments may be described as increasing saturated hydrocarbon content by a factor of at least 5, by a factor of at least 10, or a factor in the range of about 10-30, for example.

As the temperature increases, the total amount of aromatics increases and reaches a maximum of 30.3% at 450° C. This is consistent with the mechanism of aromatization due to thermal cracking. Sterols are completely removed at 350° C. indicating that dehydration requires less energy than decarboxylation. Amides dehydrate and inter-convert to the more stable nitriles. Nitriles can be further denitrogenated and produce small nitrogen compounds and saturated and unsaturated hydrocarbons.

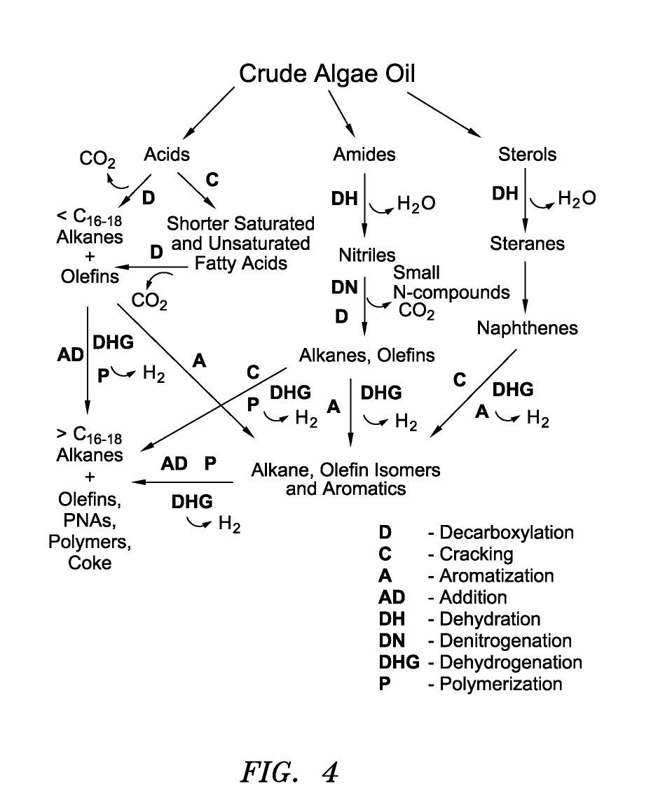

As the temperature (and/or reaction time) increases, cracking, addition, and polymerization reactions become predominant and lead to the production of polynuclear aromatics and polymers and/or coke via free radical condensation reactions. This was observed in the case of the 450° C. reaction which produced 19.3% of solids. Formation of solids and gasses may be reduced by reducing the reaction time and/or the reaction temperature. A summary of the possible reaction network for the thermal treatment of crude algae oils is shown in FIG. 4, wherein the trend of reactions from top to bottom of the figure generally correlate with increasing temperature. The reactions taking place at lower temperature (about 350° C.) are those approximately in the upper third of FIG. 4, additional reactions taking place at medium temperature (about 400° C.) are approximately in the middle third of FIG. 4, and additional reactions taking place at high temperature (about 450° C.) are approximately in the lower third of FIG. 4. One may see in FIG. 4 that decarboxylation, cracking, and dehydration are prominent in the upper third of the figure; additional, dehydrogenation, cracking, polymerization and aromatization are prominent in the middle third of the figure, and additional, dehydrogenation and polymerization are prominent in the lower third of the figure.

It may be noted that there are three main “branches” of the reaction schematic in FIG. 4, specifically, the acid branch (far left), the amide branch (middle), and the sterol branch (far right). These branches may each be seen to start with compounds (fatty acid moieties, amides, and sterols) that are very prevalent in the algae oils to be thermally-treated in many embodiments of the disclosure, but that are very low or non-existent in the fossil petroleum feedstocks typically processed thermally in units such as cokers and visbreakers. Thus, the proposed reaction scheme illustrates reactions that may provide the surprising results afforded by thermal treatment according to embodiments of the disclosure.

The results of the thermal treatment experiments clearly demonstrate that the reduction of oxygen containing compounds in algae oil and/or other renewable oils can be very efficiently achieved by thermal means.

The results of the thermal treatment experiments also clearly demonstrate that significant amounts of coke- and metals-containing solids are produced by thermal treatment of the crude algae oil, hence, removing from the algae oil many coke-precursors and metals that would deactivate a downstream catalyst were they not separated from the algae oil. Given the 1020° F.+ content of the crude algae oil being about 20-30 mass percent of the crude algae oil and including several percent of material that is non-detectable and/or non-distillable even by the rigorous methods of SIMDIST, it is believed that much of the solids are formed from the heavy materials in the crude algae oil, for example, by condensation or polymerization reactions. However, it is expected that some of the solids are formed by one or more mechanisms from some compounds in the 1020° F. minus material of the crude algae oil, for example, some of the “unknown” compounds present in the HT GC-MS chromatogram peak area but not identified. Further experimentation is needed to determine the portion of catalyst deactivation attributable to the 1020° F. minus fraction of the crude algae oil, and in certain embodiments, this portion may dictate that the entire crude algae oil, rather than only the 1020° F. plus material should be thermally-treated. This may be done, for example, as a catalyst-protection pre-treatment step before feeding crude algae oil, or a fraction thereof, to hydrotreaters, hydrocrackers, fluid catalytic cracking (FCC) or other catalytic process units. It may be found that catalyst protection in general, and catalyst run-length preservation in particular, is enhanced to a greater extent by thermally-treating the whole crude algae oil than by fractionating the crude algae oil to remove the 1020° F.+ material.

Customizing and optimization of thermal treatment of crude algae oil or fractions thereof may include considerations of deoxygenation or decarboxylation, the extent of cracking and boiling point shift, downstream catalyst deactivation, and compositional data, such as aromatics, naphthenes, and paraffin content and distribution throughout the various fractions of the liquid oil. For example, temperature ramping, maximum temperature, and/or holding time may be adjusted with the goal of achieving the desired amount of viscosity and/or density and/or boiling point reduction, the desired amount of saturation versus aromatization, and acceptable or desirable catalyst-deactivation rates in downstream units. The analysis of downstream unit catalyst deactivation may be an important part of the customizing and optimizing of thermal treatment conditions. The customizing and optimization may include a study of thermal treatment severity, for example, increased temperature and/or holding times, versus solids production, metals reduction, oxygen reduction, 1020° F.+ fraction reduction, and/or downstream unit catalyst deactivation. A study of downstream unit catalyst deactivation may be useful to determine whether increasing thermal treatment severity reduces downstream catalyst deactivation through a wide range of thermal treatment severity, or whether a point is reached with certain crude algae oils wherein an increase in thermal treatment severity does not improve certain downstream catalyst deactivation rates, or even worsens certain downstream catalyst deactivation rates. Further, the liquid oil may be studied to understand whether the compositions produced at higher thermal treatment severities will be beneficial, for example, for producing gasoline or aromatics, or whether such liquid oil product is “over-processed” and will have a net or overall negative effect on downstream units. Also, there may be important uses for algae oils, for example, as lube oil and other lubricant basestock or blending components, wherein aromatics are not desirable and therefore lower severity thermal treatment is advantageous.

In this disclosure, ranges of maximum temperature, holding time/residence time, and pressure are given for many embodiments of the disclosure. It should be understood that the ranges are intended to include sub-ranges, and each incremental amount of temperature, time, and pressure, within each broad range given. For example, while the broad range of 300-600° C. maximum temperature is mentioned for many embodiments of the disclosure, certain embodiments may include any of the following sub-ranges or any temperature within any of the following sub-ranges: 300-310, 310-320, 320-330, 330-340, 340-350, 350-360, 360-370, 370-380, 380-390, 390-400, 400-410, 410-420, 420-430, 430-440, 440-450, 450-460, 460-470, 470-480, 480-490, 490-500, 500-510, 510-520, 520-530, 530-540, 540-550, 550-560, 560-570, 570-580, 580-590, and/or 590-600° C. For example, while the broad range of 0.05-24 hours holding time is mentioned for many embodiments of the disclosure, certain embodiments may include any of the following sub-ranges or any holding time within any of the following sub-ranges: 0.05-0.1, 0.1-0.5, 0.5-1.0, 1.0-1.5, 1.5-2.0, 2.0-2.5, 2.5-3.0, 3.0-3.5, 3.5-4.0, 4.0-4.5, 4.5-5.0, 5.0-10.0, 10.0-15.0, 15.0-20.0, and/or 20.0-24.0 hours. Also, it should be understood that no holding time at maximum temperature may be effective (a zero holding time), especially when the temperature ramping schedule takes significant time. For example, while the broad range of 0-3000 psig pressure is expected for many embodiments of the disclosure, certain embodiments may include any of the following sub-ranges or any pressure within any of the following sub-ranges: 0-20, 20-40, 40-60, 60-80, 80-100, 100-120, 120-140, 140-160, 160-180, 180-200, 200-220, 220-240, 240-260, 260-280, 280-300 psig, 300-500, 500-700, 700-900, 900-1000, 1000-1100, 1100-1300, 1300-1500, 1500-1700, 1700-1900, 1900-2100, 2100-2300, 2300-2500, 2500-2700, and/or 2700-3000 psig.

Also, included as an embodiment of the disclosure is a fraction or fractions of a crude algae oil, and methods of thermally treating the fraction or fractions. Also, each of the values of yields, compound types, percent, area percent, mass percent, fraction mass percent, simulated distillation fraction mass percent yields, simulated distillation fraction mass percent, compound type area percent, chemical compound type area percent, ppms, weight percent, temperature, time, or pressure disclosed herein can have an “about” inserted before it, as one of average skill in the art will understand that “about” these values may be appropriate in certain embodiments of this disclosure.

While certain embodiments have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

What is claimed is:

1-84. (canceled)

85. A method of processing a crude algae oil or fraction thereof obtained from a biomass, the method comprising:
a) heating the crude algae oil or fraction thereof obtained from the biomass to a maximum temperature in the range of about 300-about 600 degrees Celsius to obtain a thermally-treated algae oil, wherein:
i) the thermally-treated algae oil is less dense than the crude algae oil or fraction thereof before heating;
ii) the thermally-treated algae oil has a lower heteroatom content than the crude algae oil or fraction thereof before heating;
iii) the thermally-treated algae oil has a reduced boiling point distribution compared to the crude algae oil or fraction thereof before heating; and
iv) the thermally-treated algae oil has a reduced metals content compared to the crude algae oil or fraction thereof before heating;
wherein the heating of the crude algae oil or fraction occurs without the addition of hydrogen.

86. The method of claim 84, wherein heating of the crude algae oil occurs in the absence of a catalyst.

87. The method of claim 84, wherein the thermally-treated algae oil also has:
a) increased aromatic molecules compared to the crude algae oil or fraction thereof before heating;
b) increased saturated hydrocarbon content compared to the crude algae oil or fraction thereof before heating;
c) decreased fatty acid content compared to the crude algae oil or fraction thereof before heating;
d) reduced total acid number (TAN) compared to the crude algae oil or fraction thereof before heating;
e) reduced viscosity compared to the crude algae oil or fraction thereof before heating;
f) increased nitrile content compared to the crude algae oil or fraction thereof before heating; or
g) decreased sterol content compared to the crude algae oil or fraction thereof before heating.

88. The method of claim 84, wherein the crude algae oil of step a) is obtained by hydrothermal treatment of the biomass or is obtained by a pretreatment step followed by hydrothermal treatment of the biomass.

89. The method of claim 84, wherein the biomass comprises at least one species of algae.

90. The method of claim 84, wherein the thermally-treated algae oil deactivates a subsequent unit process catalyst less quickly than does the crude algae oil or fraction thereof undergoing the same subsequent unit process conditions.

91. The method of claim 84, wherein the reduced boiling point distribution of the thermally treated algae oil has:
a) a decreased 1020 degrees F+ fraction mass percent compared to the crude algae oil or fraction thereof before heating;
b) less than or equal to about 22.7 weight % of its material boiling above 1020 degrees F.; or
c) a 1020 degrees F+ fraction mass percent of less than or equal to 22.7.

92. The method of claim 84, wherein
a) the density of the thermally-treated algae oil is from about 0.8780 (g/ml) at about 22.8 degrees Celsius to about 0.9567 (g/ml) at about 22.8 degrees Celsius;
b) the thermally-treated algae oil is 5 to 20 percent less dense than the crude algae oil; or
c) the thermally-treated algae oil is 2 to 5 percent less dense, 5-8 percent less dense, 8-11 percent less dense, 9-12 percent less dense, 12-30 percent less dense, 30-50 percent less dense, 50-80 percent less dense, 80-100 percent less dense, at least 100 percent less dense, at least 150 percent less dense, or at least 200 percent less dense than the crude algae oil.

93. The method of claim 84, wherein the heteroatom is sulfur or oxygen.

94. The method of claim 93, wherein
a) the thermally-treated algae oil has a percent oxygen content of from about 0.2 to about 2.9; or
b) the thermally-treated algae oil has a percent oxygen content of less than 6%, less than 5%, less than 4%, less than 3%, less than 2%, or less than 1%; or
c) the crude algae oil has an oxygen content of greater than or equal to 5.0 wt-% and the thermally-treated algae oil has an oxygen content of less than 5.0 wt-%; or
d) the thermally-treated algae oil a has sulfur content of from about 0.1 percent to about 0.4 percent; or
e) the thermally-treated algae oil has a reduced metals content comprising a reduction in ppms of P, Fe, Cu-63, Zn-66, or Zn-68 compared to the crude algae oil or fraction thereof before heating.

95. The method of claim 84, further comprising a step of:
a) holding the crude algae oil at the maximum temperature for a holding period in the range of from about 0.05 hour to about 8 hours, from about 0.01 hour to about 24 hours, from about 0.05 hour to about 24 hours, or from about 0.1 hour to about 1 hour; or
b) holding the crude algae oil at the maximum temperature for a holding period in the range of 0 to 24 hours, 0 to 10 hours, 0.5 hour to 2 hours, or 0.5 hour to 1 hour; or
c) holding the crude algae oil at the maximum temperature for a holding period in the range of 0.05 hours to 8 hours, wherein the heating and holding are performed in one or more vessels and the heating releases and/or forms gas and/or light hydrocarbons that increase pressure in the one or more vessels to a range of 0 psig-1000 psig, 300 psig to 3,000 psig, 0 psig to 100 psig, or 0 psig-300 psig: or
d) holding the crude algae oil at the maximum temperature for a holding period in the range of 0.05 hours to 8 hours, wherein the holding is performed during continuous flow through one or more vessels, and the heating releases and/or forms gas and/or light hydrocarbons that increase pressure in the one or more vessels and that are separated after the thermally-treated algae oil exits the one or more vessels.

96. The method of claim 84, wherein the maximum temperature is:
a) from about 350 degrees Celsius to about 450 degrees Celsius;
b) is 300-310, 310-320, 320-330, 330-340, 340-350, 350-360, 360-370, 370-380, 380-390, 390-400, 400-410, 410-420, 420-430, 430-440, 440-450, 450-460, 460-470, 470-480, 480-490, 490-500, 500-510, 510-520, 520-530, 530-540, 540-550, 550-560, 560-570, 570-580, 580-590, or 590-600° C.; or
c) is about 350 degrees Celsius, about 400 degrees Celsius, or about 450 degrees Celsius.

97. The method of claim 84, wherein
a) the method yields greater than or equal to 40 wt-% thermally-treated algae oil, and less than or equal to 20 wt % solids, the remainder of the yield being gasses; greater than or equal to 75 wt-% thermally-treated algae oil, and less than or equal to 10 wt % solids, the remainder of the yield being gasses; or greater than or equal to 80 wt-% thermally-treated algae oil, and less than or equal to 5 wt % solids, the remainder of the yield being gasses; or
b) the crude algae oil contains 10-20 mass percent material boiling below 630 degrees F. and the thermally-treated algae oil contains greater than 20 mass percent material boiling below 630 degrees F.; the crude algae oil contains 10-20 mass percent material boiling below 630 degrees F, and the thermally-treated algae oil contains greater than 50 mass percent material boiling below 630 degrees F.; the crude algae oil contains 10-20 mass percent material boiling below 630 degrees F, and the thermally-treated algae oil contains greater than 80 mass percent material boiling below 630 degrees F.; the crude algae oil contains less than or equal to 5 mass percent material boiling below 400 degrees F, and the thermally-treated algae oil contains greater than or equal to 15 mass percent material boiling below 400 degrees F.; or the crude algae oil contains less than or equal to 5 mass percent material boiling below 400 degrees F, and the thermally-treated algae oil contains greater than or equal to 50 mass percent material boiling below 400 degrees F.; or
c) the thermally-treated algae oil contains greater than or equal to 20 mass percent material boiling below 630 degrees F.; the thermally-treated algae oil contains greater than or equal to 50 mass percent material boiling below 630 degrees F.; the thermally-treated algae oil contains greater than or equal to 80 mass percent material boiling below 630 degrees F.; the thermally-treated algae oil contains greater than or equal to 15 mass percent material boiling below 400 degrees F.: the thermally-treated algae oil contains greater than or equal to 50 mass percent material boiling below 400 degrees F.; the thermally-treated algae oil contains less than or equal to 10 mass percent fatty acid moieties: or the thermally-treated algae oil contains less than or equal to 10 mass percent amides plus fatty acids plus sterols.

98. A thermally-treated algae oil made by the method of claim 84.

99. A method of processing a crude algae oil or fraction thereof obtained from a biomass, the method comprising:
a) heating the crude algae oil or fraction thereof obtained from the biomass in a closed reactor to a maximum temperature in the range of about 300 to about 600 degrees Celsius to obtain a thermally-treated algae oil; and
b) holding the maximum temperature or a temperature that is within 5 to 10 degrees Celsius of the maximum temperature for 0 to 24 hours;
wherein the heating and holding of the crude algae oil or fraction occurs without the addition of hydrogen.

100. The method of claim 99, wherein the heating of the crude algae oil or fraction also occurs in the absence of a catalyst.

101. The method of claim 99, wherein: the maximum temperature is about 350 to about 450 degrees Celsius, or is about 350 degrees Celsius, or is about 400 degrees Celsius, or is about 450 degrees Celsius.

102. The method of claim 99, wherein: the thermally-treated algae oil is less dense than the crude algae oil or fraction thereof before heating; the thermally-treated algae oil has a lower heteroatom content than the crude algae oil or fraction thereof before heating; the thermally-treated algae oil has a reduced boiling point distribution compared to the crude algae oil or fraction thereof before heating; and the thermally-treated algae oil has a reduced metals content compared to the crude algae oil or fraction thereof before heating.

103. A thermally-treated algae oil, wherein:
a) the thermally-treated algae oil is less dense than a non-thermally treated crude algae oil or fraction thereof obtained from the same species;
b) the thermally-treated algae oil has a lower heteroatom content than a non-thermally treated crude algae oil or fraction thereof obtained from the same species;
c) the thermally-treated algae oil has a reduced boiling point distribution compared to a non-thermally treated crude algae oil or fraction thereof obtained from the same species; and
d) the thermally-treated algae oil has a reduced metals content compared to a non-thermally treated crude algae oil or fraction thereof obtained from the same species:
wherein the thermal treatment of the crude algae oil or fraction thereof is between about 300 to about 600 degrees Celsius.

104. A thermally-treated algae oil, wherein:
a) the thermal treatment is heating a crude algae oil to a temperature of about 350 degrees Celsius, and oil yield after thermal treatment is about 86.6 percent or greater; or the thermal treatment is heating a crude algae oil to a temperature of about 400 degrees Celsius, and oil yield after thermal treatment is about 81.9 percent or greater; or the thermal treatment is heating a crude algae oil to a temperature of about 450 degrees Celsius, and oil yield after thermal treatment is about 40.9 percent or greater; or
b) the thermal treatment is heating a crude algae oil to a temperature of about 350 degrees Celsius, and oil yield after thermal treatment is about 86.6 percent and solid yield after thermal treatment is about 0.4 percent; or the thermal treatment is heating a crude algae oil to a temperature of about 400 degrees Celsius, and oil yield after thermal treatment is about 81.9 percent and solid yield after thermal treatment is about 8.1 percent; or the thermal treatment is heating a crude algae oil to a temperature of about 450 degrees Celsius, and oil yield after thermal treatment is about 40.9 percent and solid yield after thermal treatment is about 19.3 percent; or
c) the thermal treatment is heating a crude algae oil to a temperature of about 350 degrees Celsius, and oil yield after thermal treatment is about 86.6 percent, solid yield is about 0.4 percent, gas yield is about 2.6 percent, losses is about 10.4 percent, and Pmax (psi) is about 460; or the thermal treatment is heating a crude algae oil to a temperature of about 400 degrees Celsius, and oil yield after thermal treatment is about 81.9 percent, solid yield is about 8.1 percent, gas yield is about 6.3 percent, losses is about 3.7 percent, and Pmax (psi) is about 610; or the thermal treatment is heating a crude algae oil to a temperature of about 450 degrees Celsius, and oil yield after thermal treatment is about 40.9 percent, solid yield is about 19.3 percent, gas yield is about 18.3 percent, losses is about 21.4 percent, and Pmax (psi) is about 2910; or
d) the thermal treatment is heating a crude algae oil to a temperature of about 350 degrees Celsius; and the thermally-treated algae oil has about 80.8% C, about 11.6% H, about 4.3% N, about 0.4% S, about 2.9% 0, a heating value (MJ/kg) of about 44, and a density (g/ml) at about 22.8 degrees Celsius of about 0.9567; or the thermal treatment is heating a crude algae oil to a temperature of about 400 degrees Celsius; and the thermally-treated algae oil has about 83.6% C, about 11.7% H, about 4.2% N, about 0.4% S, about 0.2% O, a heating value (MJ/kg) of about 45, and a density (g/ml) at about 22.8 degrees Celsius of about 0.9164; or the thermal treatment is heating a crude algae oil to a temperature of about 450 degrees Celsius; and the thermally-treated algae oil has about 84.0% C, about 10.1% H, about 4.2% N, about 0.1% S, about 1.6% O, a heating value (MJ/kg) of about 43, and a density (g/ml) at about 22.8 degrees Celsius of about 0.8780; or the thermal treatment is heating a crude algae oil to a temperature of about 350 to about 450 degrees Celsius; and the thermally-treated algae oil has a % C and a heating value (MJ/kg) that is greater than the crude algae oil before heating, and a % H, a % S, a % 0, and a density (g/ml) at about 22.8 degrees Celsius that are each individually less than for the crude algae oil before heating; or
e) the thermal treatment is heating a crude algae oil to a temperature of about 350 degrees Celsius; and for the thermally-treated algae oil, initial—260 degrees F. fraction mass % is 0.0, 260-400 degrees F. fraction mass % is about 2.1; 400 to 490 degrees F. fraction mass % is about 5.2; 490 to 630 degrees F. fraction mass % is about 17.8; 630-1020 degrees F. fraction mass % is about 52.3; and 1020 degrees F.—FBP is about 22.5; or the thermal treatment is heating a crude algae oil to a temperature of about 400 degrees Celsius; and for the thermally-treated algae oil, initial—260 degrees F. fraction mass % is about 6.5, 260-400 degrees F. fraction mass % is about 11.4; 400 to 490 degrees F. fraction mass % is about 12.0; 490 to 630 degrees F. fraction mass % is about 27.2; 630-1020 degrees F. fraction mass % is about 36.0; and 1020 degrees F.—FBP is about 7.0; or the thermal treatment is heating a crude algae oil to a temperature of about 450 degrees Celsius; and for the thermally-treated algae oil, initial—260 degrees F. fraction mass % is about 23.3, 260-400 degrees F. fraction mass % is about 28.0; 400 to 490 degrees F. fraction mass % is about 14.5; 490 to 630 degrees F. fraction mass % is about 16.1; 630-1020 degrees F. fraction mass % is about 16.5; and 1020 degrees F.—FBP is about 1.7; or the thermal treatment is heating a crude algae oil to a temperature of about 350 to about 450 degrees Celsius; and for the thermally-treated algae oil, initial—260 degrees F. fraction mass % is 0.0 to about 23.3 percent, 260-400 degrees F. fraction mass % is greater than that of the crude algae oil; 400 to 490 degrees F. fraction mass % is greater than that of the crude algae oil; 490 to 630 degrees F. fraction mass % is greater than that of the crude algae oil; 630-1020 degrees F. fraction mass % is less than that of the crude algae oil; and 1020 degrees F.—FBP is less than that of the crude algae oil: or
f) the thermal treatment is heating a crude algae oil to a temperature of about 350 to about 450 degrees Celsius; and for the thermally-treated algae oil, area % of saturated hydrocarbons is about 23.2 to about 36.6, area % of unsaturated hydrocarbons is about 1.5 to about 5.4, area % of aromatic compounds is about 0.3 to about 30.3, area % of amides is about 0.0 to about 8.5, area % of nitriles is about 0.5 to about 12.3, area % of nitrogen aromatics is 0.0 to about 3.5, area % of fatty acids is 0.0 to about 5.2, area % of sterols is 0.0, area % of oxygen containing compounds is about 0.7 to about 1.0, and area % of sulfur containing compounds is 0.0 to about 1.4.
